(19) United States
(12) Patent Application Publication
(10) Pub. No.: US 2013/0293687 A1
(43) Pub. Date: Nov. 7, 2013

(54) STEREOSCOPIC IMAGE PROCESSING APPARATUS, STEREOSCOPIC IMAGE PROCESSING METHOD, AND PROGRAM

(71) Applicants: Mikio Seto, Osaka-shi (JP); Hisao Hattori, Osaka-shi (JP); Ken-ichiro Yamamoto, Osaka-shi (JP); Hisao Kumai, Osaka-shi (JP); Ikuko Tsubaki, Osaka-shi (JP)

(72) Inventors: Mikio Seto, Osaka-shi (JP); Hisao Hattori, Osaka-shi (JP); Ken-ichiro Yamamoto, Osaka-shi (JP); Hisao Kumai, Osaka-shi (JP); Ikuko Tsubaki, Osaka-shi (JP)

(73) Assignee: SHARP KABUSHIKI KAISHA, Osaka-shi, Osaka (JP)

(21) Appl. No.: 13/979,345

(22) PCT Filed: Jan. 12, 2012
(86) PCT No.: PCT/JP2012/050438

§ 371 Date: Jul. 11, 2013

(30) Foreign Application Priority Data
Jan. 14, 2011 (JP) 2011-006261

(51) Int. Cl. H04N 13/00

(52) U.S. Cl. CPC H04N 13/0018
USPC 348/51

(57) ABSTRACT

There is generated an image where a guide image that represents a position in real space of a display unit configured to display a stereoscopic image and serves as a reference of depth in the stereoscopic image is overlapped on the stereoscopic image, thereby generating a stereoscopic image where a viewer can readily recognize a forward/backward position of an object within the stereoscopic image.

### TECHNICAL FIELD

The present invention relates to a stereoscopic image processing apparatus, a stereoscopic image processing method, and a program.

The present application claims priority based on Japanese Patent Application No. 2011-006261, filed in Japan on Jan. 14, 2011, the content of which is incorporated herein by reference.

### BACKGROUND ART

When a human being senses depth of an object situated in space, he/she uses positional deviation of an image to be projected on both eyes, that is, binocular parallax, as a clue.

Examples of a system using an arrangement of this binocular parallax include a stereoscopic image display system. With a stereoscopic image display system, stereoscopic vision is realized (depth is expressed) by providing an image corresponding to the left to the left eye (alone) and an image corresponding to the right to the right eye (alone).

At this time, three-dimensional spatial information is projected on two-dimensional left and right images (, and is spatially compressed). Therefore, according to a spatial-like (three-dimensional-like) position of an object, deviation occurs on each of two-dimensionally projected left and right images. This serves as parallax difference.

Conversely, the differing of parallax differences agrees with the differing of three-dimensional (-like) positions. Accordingly, a spatial-like position of an object projected on an image can be adjusted by virtually adjusting parallax difference between left and right images, and consequently, depth sensation can be operated.

With PTL 1, there is the following description regarding a stereoscopic video processing apparatus whereby an observer can optionally adjust parallax difference.

1) At the time of adjusting a display position of a stereoscopic video forward or backward by a user's operations, of multiple rectangular pieces arrayed on up, down, left, and right ends of a display (video display region) so as to extend forward and backward, control is performed so that a rectangular piece of which the forward and backward positions agree with those of a stereoscopic video differs from another rectangular piece in color, or control is performed so that a rectangular piece corresponding to depth width of a stereoscopic video differs from another rectangular piece in color, thereby facilitating adjustment operation.

2) Linear pitch pieces are arrayed on up, down, left, and right ends of a display (video display region) in forward and backward directions, and also along with forward and backward adjustment of a display position of a stereoscopic video where a semitransparent virtual screen is displayed between up and down, or left and right pitch pieces agreeing with the display position of the stereoscopic video, the virtual screen also moves forward or backward, and after adjustment, the pitch pieces and virtual screen are eliminated.

3) In accordance with a control signal from a remote control interface, output or stop of an image for reference is controlled.

### CITATION LIST

### Patent Literature

PTL 1: Japanese Unexamined Patent Application Publication No. 11-155155

### SUMMARY OF INVENTION

### Technical Problem

However, with a stereoscopic display system according to the related art, in the event of having displayed a stereoscopic image, it is not comprehended in some cases whether an object within the stereoscopic image is an object which protrudes from an image display screen face (e.g., a display surface of a video display machine) in real space, or an object which is recessed towards the back, that is, there is a problem in that a position in the forward or backward direction is not comprehended. For example, with the invention disclosed in PTL 1, a depth sensation guide thereof itself is also displayed in a stereoscopic manner so as to extend forward or backward from the screen face, and accordingly, even when a relative positional relation between the stereoscopic video and depth sensation guide is comprehended, it may not be understood whether the video is a video where the object protrudes from the screen face in real space or a video where the object is recessed towards the back.

The present invention has been made in the light of such a situation, and it is an object thereof to provide a stereoscopic image processing apparatus, a stereoscopic image processing method, and a program which generate a stereoscopic image where a viewer can readily recognize a position in the forward and backward directions of an object within the stereoscopic image.

### Solution to Problem

(1) The present invention has been made to solve the above-mentioned problem, and one mode of the present invention is a stereoscopic image processing apparatus configured to generate an image where a guide image that represents a position in real space of a display unit configured to display a stereoscopic image and serves as a reference of depth in the stereoscopic image is overlapped on the stereoscopic image.

(2) Also, another mode of the present invention is the stereoscopic image processing apparatus wherein the guide image is an image to be sensed on an image display screen face of the display unit or on a planar surface in parallel with the image display screen and in the vicinity of the image display screen face.

(3) Also, another mode of the present invention is the stereoscopic image processing apparatus wherein the guide image is a portion of an image viewed from one viewpoint that makes up the stereoscopic image.

(4) Also, another mode of the present invention is the stereoscopic image processing apparatus wherein based on depth data of the stereoscopic image, an image where the guide image is overlapped on the stereoscopic image is generated.

(5) Also, another mode of the present invention is the stereoscopic image processing apparatus wherein a composite parameter in the event of overlapping the guide image on the stereoscopic image is set to a different value depending on whether a portion where the guide image and the stereoscopic image are overlapped is a foreground portion which is a subject portion to be sensed more toward the near side from the image display screen or a background portion which is a subject portion to be sensed more toward the far side from the image display screen.

(6) Also, another mode of the present invention is the stereoscopic image processing apparatus wherein the composite parameter is transparency of the guide image, and sets transparency in the foreground portion greater than transparency in the background portion.

(7) Also, another mode of the present invention is the stereoscopic image processing apparatus wherein transparency in the foreground portion is 100%.

(8) Also, another mode of the present invention is the stereoscopic image processing apparatus wherein the composite parameter is lateral width of the guide image, and sets lateral width in the foreground portion smaller than lateral width in the background portion.

(9) Also, another mode of the present invention is the stereoscopic image processing apparatus wherein a display position of the guide image is changed over time.

(10) Also, another mode of the present invention is a stereoscopic image processing method for processing a stereoscopic image, including: generating an image where a guide image that represents a position in real space of a display unit configured to display a stereoscopic image and serves as a reference of depth in the stereoscopic image is overlapped on the stereoscopic image.

(11) Also, another mode of the present invention is a program causing a computer of a stereoscopic image processing apparatus configured to process a stereoscopic image to execute: generating an image where a guide image that represents a position in real space of a display unit configured to display a stereoscopic image and serves as a reference of depth in the stereoscopic image is overlapped on the stereoscopic image.

### Advantageous Effects of Invention

According to the present invention, there is generated a stereoscopic image where a viewer can readily recognize a position in the forward and backward directions of an object within the stereoscopic image.

### BRIEF DESCRIPTION OF DRAWINGS

FIG. 1 is a schematic block diagram illustrating a configuration of a stereoscopic image processing apparatus 10 according to a first embodiment of the present invention.

FIG. 2 is an image example for describing image data of a stereoscopic image conforming to a side-by-side format.

FIG. 3 is an image example for describing image data of a stereoscopic image conforming to a top-and-bottom format.

FIG. 4 is a conceptual diagram for describing image data of a stereoscopic image conforming to a frame sequential format.

FIG. 5 is a schematic block diagram illustrating a configuration of a stereoscopic image input unit 1A according to the first embodiment.

FIG. 6 is a flowchart for describing operation of the stereoscopic image input unit 1A according to the first embodiment.

FIG. 7 is a schematic diagram (No. 1) for describing a depth sensation guide according to the first embodiment.

FIG. 8 is a schematic diagram (No. 2) for describing the depth sensation guide according to the first embodiment.

FIG. 9 is a schematic diagram (No. 3) for describing the depth sensation guide according to the first embodiment.

FIG. 10 is a schematic block diagram illustrating a configuration of a depth sensation guide generator 1B according to the first embodiment.

FIG. 11 is a diagram illustrating an example of a depth sensation guide parameter and an updating priority flag according to the first embodiment.

FIG. 12 is a diagram illustrating an example (No. 1) of the depth sensation guide according to the first embodiment.

FIG. 13 is a diagram illustrating an example (No. 2) of the depth sensation guide according to the first embodiment.

FIG. 14 is a diagram illustrating an example (No. 3) of the depth sensation guide according to the first embodiment.

FIG. 15 is a diagram illustrating an example (No. 4) of the depth sensation guide according to the first embodiment.

FIG. 16 is a diagram illustrating an example (No. 5) of the depth sensation guide according to the first embodiment.

FIG. 17 is a diagram illustrating an example (No. 6) of the depth sensation guide according to the first embodiment.

FIG. 18 is a diagram illustrating an example (No. 7) of the depth sensation guide according to the first embodiment.

FIG. 19 is a diagram illustrating an example (No. 8) of the depth sensation guide according to the first embodiment.

FIG. 20 is a diagram illustrating an example (No. 9) of the depth sensation guide according to the first embodiment.

FIG. 21 is a flowchart for describing operation of a depth sensation guide parameter adjusting unit 5B according to the first embodiment.

FIG. 22 is a schematic block diagram illustrating a configuration of a stereoscopic display image generator 1E according to the first embodiment.

FIG. 23 is a flowchart for describing operation of the stereoscopic display image generator 1E according to the first embodiment.

FIG. 24 is a diagram illustrating an image example (No. 1) for describing binocular rivalry.

FIG. 25 is a diagram illustrating an image example (No. 2) for describing binocular rivalry.

FIG. 26 is a diagram illustrating an image example (No. 3) for describing binocular rivalry.

FIG. 27 is a schematic block diagram illustrating a configuration of a stereoscopic image processing apparatus 11 according to a second embodiment of the present invention.

FIG. 28 is a schematic block diagram illustrating a configuration of a stereoscopic display image generator 11E according to the second embodiment.

FIG. 29 is a flowchart for describing operation of the stereoscopic display image generator 11E according to the second embodiment.

FIG. 30 is a diagram illustrating an example of a depth sensation guide with transparency of a foreground portion according to the second embodiment as 100%.

FIG. 31 is a diagram illustrating an example of a depth sensation guide so as to differ transparency between a foreground portion and a background portion according to the second embodiment.

FIG. 32 is a diagram illustrating a modification of a depth sensation guide with transparency of the foreground portion according to the second embodiment as 100%.

FIG. 33 is a schematic block diagram illustrating a configuration of a stereoscopic image processing apparatus 11′ according to a modification of the second embodiment of the present invention.

FIG. 34 is a schematic block diagram illustrating a configuration of a stereoscopic display image generator 11E′ according to the modification.

FIG. 35 is a diagram illustrating an example of a stereoscopic image composited by a stereoscopic display image compositing unit 17A′ according to the modification.

FIG. 36 is a conceptual diagram for describing a depth sensation guide example in FIG. 35 according to the modification.

FIG. 37 is a schematic block diagram illustrating a configuration of a stereoscopic image input unit 1A′ according to the second embodiment of the present invention and the modification thereof.

FIG. 38 is a diagram illustrating an example of a three-viewpoint stereoscopic image.

FIG. 39 is a schematic block diagram illustrating a configuration of a stereoscopic image input unit 13A according to a third embodiment of the present invention.

FIG. 40 is a flowchart for describing operation of a stereoscopic image format converter 33B according to the third embodiment.

FIG. 41 is a schematic block diagram illustrating a configuration of a stereoscopic image input unit 14A according to a fourth embodiment of the present invention and a relation between the stereoscopic image input unit 14A and a metadata input unit 14C.

FIG. 42 is a diagram illustrating an example of correlation between a viewpoint mode and a configuration of an image stored in an LUT 44A according to the fourth embodiment.

FIG. 43 is a diagram illustrating another example of correlation between a viewpoint mode and a configuration of an image stored in the LUT 44A according to the fourth embodiment.

FIG. 44 is a flowchart for describing operation of a stereoscopic image format converter 43B according to the fourth embodiment.

FIG. 45 is a schematic block diagram illustrating a configuration of a stereoscopic image input unit 15A according to a fifth embodiment of the present invention and a relation between the stereoscopic image input unit 15A and a metadata input unit 15C.

FIG. 46 is a diagram illustrating an example of correlation between viewpoint priority and a configuration of an image stored in an LUT 54A according to the fifth embodiment.

FIG. 47 is a flowchart for describing operation of a stereoscopic image format converter 53B according to the fifth embodiment.

FIG. 48 is a schematic block diagram illustrating a configuration of a stereoscopic image input unit 16A according to a sixth embodiment of the present invention and a relation between the stereoscopic image input unit 16A and a metadata input unit 16C.

FIG. 49 is a flowchart for describing operation of a viewing-and-listening priority determining unit 64A and a stereoscopic image format converter 53B according to the sixth embodiment.

### DESCRIPTION OF EMBODIMENTS

### First Embodiment

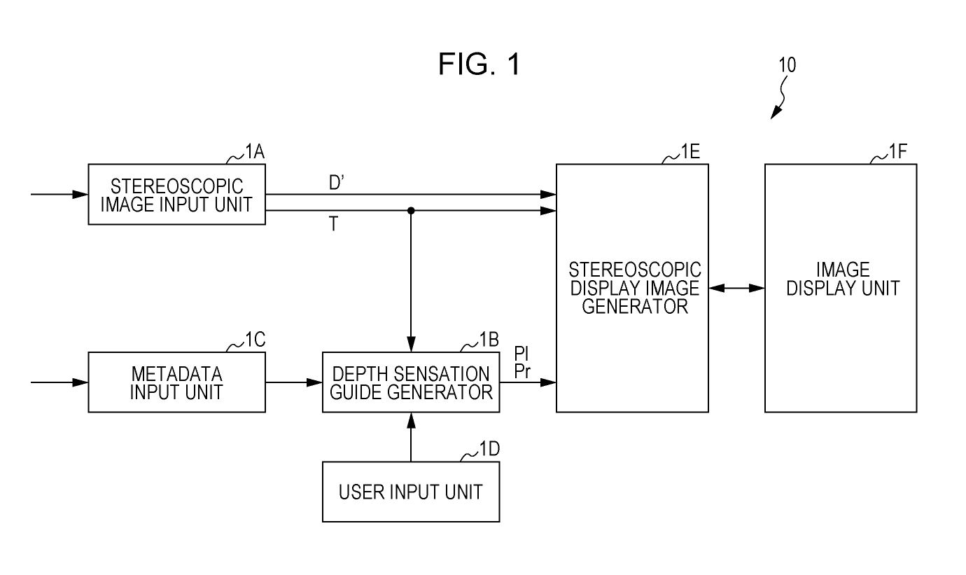

Hereinafter, a first embodiment of the present invention will be described with reference to the drawings. FIG. 1 is a schematic block diagram illustrating a configuration of a stereoscopic image processing apparatus 10 according to the present embodiment. Examples of the stereoscopic image processing apparatus 10 include a television receiver, a digital camera, a projector, a cellular phone, and an electronic photo frame, which are configured to display stereoscopic images. The stereoscopic image processing apparatus 10 is configured to include a stereoscopic image input unit 1A, a depth sensation guide generator 1B, a metadata input unit 1C, a user input unit 1D, a stereoscopic display image generator 1E, and an image display unit 1F.

The stereoscopic image input unit 1A externally accepts input of image data of a stereoscopic image. The stereoscopic image input unit 1A outputs image data D′ of the accepted stereoscopic image to the stereoscopic display image generator 1E. The stereoscopic image input unit 1A outputs format information T which indicates a format of the accepted image data to the depth sensation guide generator 1B and stereoscopic display image generator 1E.

Examples of the stereoscopic image input unit 1A include a tuner configured to receive broadcast waves, an HDMI (registered trademark) (High-Definition Multimedia Interface) receiver configured to accept video signals from an external device such as a Blu-ray (registered trademark) disc player, or the like. Note that the image data of a stereoscopic image mentioned here is a stereoscopic image to be expressed by various formats, for example, such as a top-and-bottom format (format where left and right images are stored as images in one frame so as to be vertically arrayed), a side-by-side format (format where left and right images are stored as images in one frame so as to be horizontally arrayed), and a frame sequential format (format where a left image and a right image are input over time), and so forth.

Note that, with the above stereoscopic image example, two viewpoints of the left and right are taken as an example, but for example, there may be a stereoscopic image having multi-viewpoints such as a stereoscopic image taken by a multi-view imaging system. Also, the image data D′ that the stereoscopic image input unit 1A outputs to the stereoscopic display image generator 1E may have a format of the image data accepted by the stereoscopic image input unit 1A without change, or may be output after being converted into an existing format such as a top-and-bottom format by the stereoscopic image input unit 1A. In the event that the stereoscopic image input unit 1A converts the format of the image data accepted into an existing format, the format information that the stereoscopic image input unit 1A outputs is information that indicates a format after conversion.

The depth sensation guide generator 1B generates a parameter Pl for the left eye and a parameter Pr for the right eye which are parameters for a depth sensation guide (guide image) to be composited on a stereoscopic image. The details of the depth sensation guide generator 1B and depth sensation guide will be described later.

The metadata input unit 10 externally accepts input of various types of metadata. The metadata mentioned here is data regarding image data of a stereoscopic image accepted by the stereoscopic image input unit 1A. In addition to the parameter information for a depth sensation guide, examples of the metadata include various types of data such as depth data regarding a stereoscopic image (also called a disparity map, distance image, depth image, or the like), and genre information to be obtained as content information.

The metadata input unit 10 outputs, of the accepted metadata, the parameter information for a depth sensation guide to a metadata input determining unit 5C (which will be described later) within the depth sensation guide generator 1B.

Note that, in the event of obtaining metadata using the same route as with the image data of a stereoscopic image, the metadata input unit 1C may share a configuration for obtaining metadata and a configuration for the stereoscopic image input unit 1A obtaining an image. For example, when image data and metadata are being transmitted by broadcast waves, the metadata input unit 1C shares a tuner configured to receive broadcast waves along with the stereoscopic image input unit 1A. Note that image data and metadata may be obtained from separate sources such that image data is transmitted by broadcast waves, and metadata is obtained via the Internet or the like.

The user input unit 1D detects an input operation by a user and outputs input operation information that indicates the detected input operation to the depth sensation guide generator 1B. Examples of an input operation by a user include input by a remote controller, keyboard, or mouse. Note that an arrangement may be made wherein the user input unit 1D includes an imaging device, and is configured to capture a user's gesture based on images imaged by this imaging device, and is not restricted to particular one as long as this can detect input operations by a user. Note that examples of input operations by a user include a command for turning on/off display of a depth guide.

The stereoscopic display image generator 1E generates a signal for displaying a stereoscopic image on which a depth sensation guide is composited, based on the image data D′ and format information T of a stereoscopic image from the stereoscopic image input unit 1A, and the parameter Pl for the left eye and parameter Pr for the right eye of the depth sensation guide from the depth sensation guide generator 1B.

The image display unit 1F receives a signal for displaying a stereoscopic image that the stereoscopic display image generator 1E has generated, and based on this signal, displays a stereoscopic display image on an image display screen face which the image display unit 1F includes. Note that this image display screen may be a screen configured to alternately display an image for the left eye and an image for the right eye on a liquid crystal display or plasma display or the like, and to operate a liquid crystal shutter of glasses with a liquid crystal shutter worn by a viewer in sync with this display, or may be a liquid crystal display which enables naked eye stereoscopic vision, such as a display using a parallax barrier method, lenticular method, or the like.

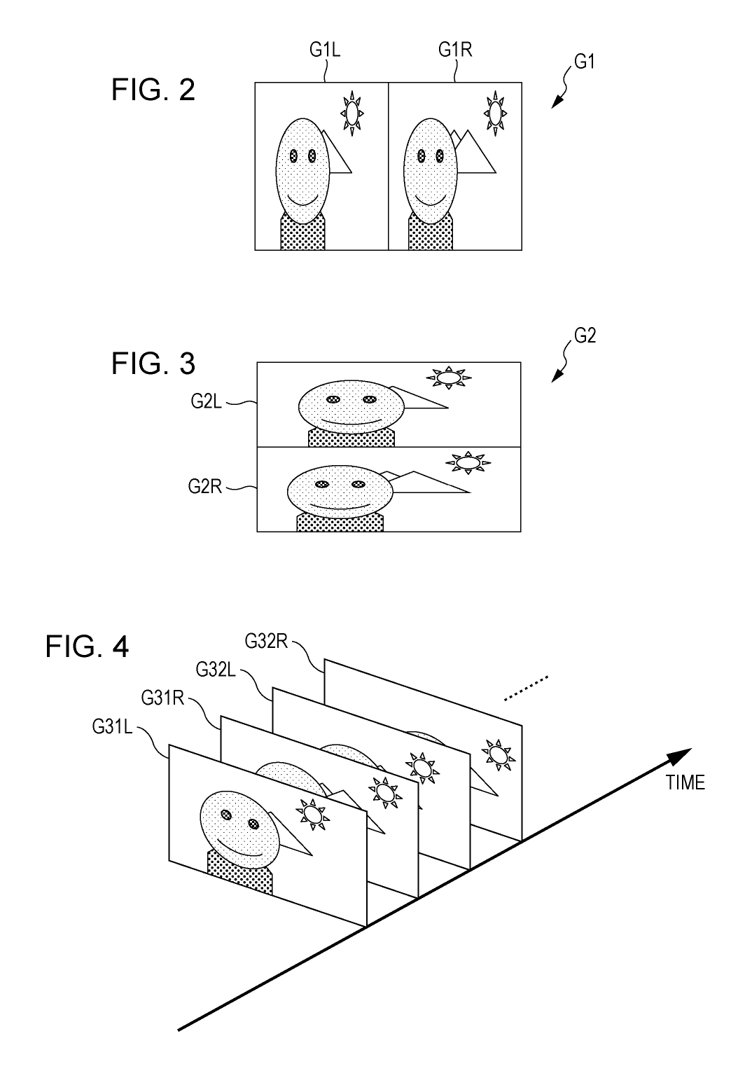

FIG. 2 is an image example for describing image data of a stereoscopic image conforming to the side-by-side format. As illustrated in this image example G1, with a stereoscopic image conforming to the side-by-side format, one frame is horizontally divided, and the left-side half serves as an image G1L for the left eye, and the right side half serves as an image G1R for the right eye. FIG. 3 is an image example for describing image data of a stereoscopic image conforming to the top-and-bottom format. As illustrated in this image example G2, with a stereoscopic image conforming to the top-and-bottom format, one frame is vertically divided, and the upper-side half serves as an image G2L for the left eye, and the lower side half serves as an image G2R for the right eye. Note that, conversely, there may be a format where the upper side serves as an image for the right eye, and the lower side serves as an image for the left eye.

FIG. 4 is a conceptual diagram for describing image data of a stereoscopic image conforming to the frame sequential format. With image data of a stereoscopic image conforming to the frame sequential format, images for the left eye and images for the right eye are alternately arrayed in the time direction. With the example illustrated in FIG. 4, of frames arrayed in the temporal direction in order of G31L, G31R, G32L, and G32R, the G31L and G32L are images for the left eye, and the G31R and G32R are images for the right eye.

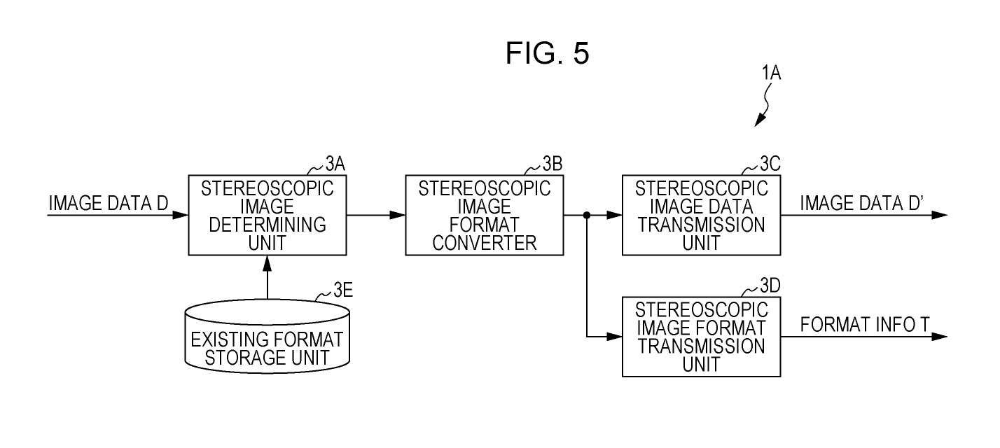

FIG. 5 is a schematic block diagram illustrating a configuration of the stereoscopic image input unit 1A. As illustrated in FIG. 5, the stereoscopic image input unit 1A is configured to include a stereoscopic image determining unit 3A, a stereoscopic image format converter 3B, a stereoscopic image data transmission unit 3C, a stereoscopic image format transmission unit 3D, and an existing format storage unit 3E. The stereoscopic image determining unit 3A determines a format of the accepted image data D, and determines whether or not the format thereof is an existing format stored in the existing format storage unit 3E. The stereoscopic image format converter 3B converts the accepted image data D into image data D′ conforming to an existing format. The stereoscopic image data transmission unit 3C outputs the image data D′ converted by the stereoscopic image format converter 3B. The stereoscopic image format transmission unit 3D outputs format information T that indicates the format of the image data output by the stereoscopic image data transmission unit 3C. The existing format storage unit 3E stores information that indicates an existing format, beforehand. Note that, when there is no existing format, the existing format storage unit 3E stores information that indicates that there is no existing format, or does not store information that indicates a format.

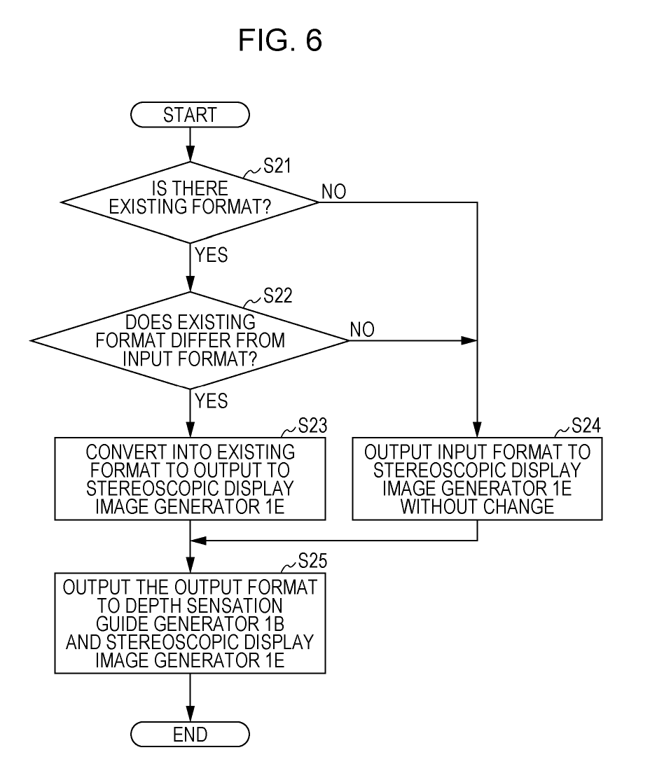

FIG. 6 is a flowchart for describing operation of the stereoscopic image input unit 1A. As illustrated in FIG. 6, first, in step S21, the stereoscopic image determining unit 3A determines whether or not an existing format of the image data DT to be transmitted to the stereoscopic display image generator 1E is stored in the exiting format storage unit 3E. Now, examples of the existing format include the side-by-side format, top-and-bottom format, and frame sequential format which are illustrated in FIG. 2 to FIG. 4. As a result of this determination, when the existing format is stored (Y in S21), the flow proceeds to step S22. On the other hand, as a result of the determination in step S21, when no existing format is stored (N in S21), the flow proceeds to step S24.

In step S22, the stereoscopic image determining unit 3A determines whether or not the existing format stored in the existing format storage unit 3E and the format of the accepted image data D differ. As a result of this determination, when the existing format and the format of the accepted image data D differ (Y in S22), the flow proceeds to step S23. On the other hand, as a result of the determination in step S22, when the existing format and the format of the accepted image data D do not differ (agree) (N in S22), the flow proceeds to step S24.

In step S23, the stereoscopic image format converter 3B converts the accepted image data D into the image data D′ conforming to the existing format. Further, the stereoscopic image data transmission unit 3C outputs the converted image data D′ to the stereoscopic display image generator 1E, and the flow proceeds to step S25.

In step S24, the stereoscopic image format converter 3B does not perform conversion processing as to the accepted image data D, and outputs this image data D to the stereoscopic image data transmission unit 3C as the image data D′ to be output. Further, the stereoscopic image data transmission unit 3C outputs the image data D′ output from the stereoscopic image format converter 3B to the depth sensation guide generator 1B, and the flow proceeds to step S25.

In step S25, the stereoscopic image format converter 3B outputs format information T that indicates the format of the image data D′ output in step S23 or step S24, to the stereoscopic image format transmission unit 3D. The stereoscopic image format transmission unit 3D outputs the format information T output from the stereoscopic image format converter 3B to the depth sensation guide generator 1B and stereoscopic display image generator 1E.

Though description has been made so far regarding a case where a stereoscopic image has been input, in the event that a planar (2D) image has been input, an arrangement may be made wherein processing is not performed on this image at the units, and the image is output to the image display unit 1F to display the planar image without change.

Alternatively, the stereoscopic image format converter 3B of the stereoscopic image input unit 1A may newly create the image data of a stereoscopic image by performing 2D to 3D conversion processing (processing for creating a 3D image from a 2D image).

Next, description will be made regarding a depth sensation guide. The depth sensation guide is displayed so as to be sensed on the image display screen face (a surface where an image is projected, which is a surface where distance from the viewer is clear in real space, e.g., such as a display displaying screen of a liquid crystal display, a screen face where an image from a projector is projected, or the like) or on a planar surface in parallel with the screen face and also in the vicinity of the screen face.

Note that it is desirable that distance from the image display screen face is 0 (parallax is 0 in a stereo image), that is, it is desirable that distance from the viewer to the depth sensation guide, and distance from the viewer to the image display screen face are the same distance in real space.

However, with the present invention, distance from the viewer to the depth sensation guide, and distance from the viewer to the image display screen face are generally the same in real space, that is, as long as the viewer can sense that the depth sensation guide is on the image display screen face, parallax may not necessarily be 0 physically.

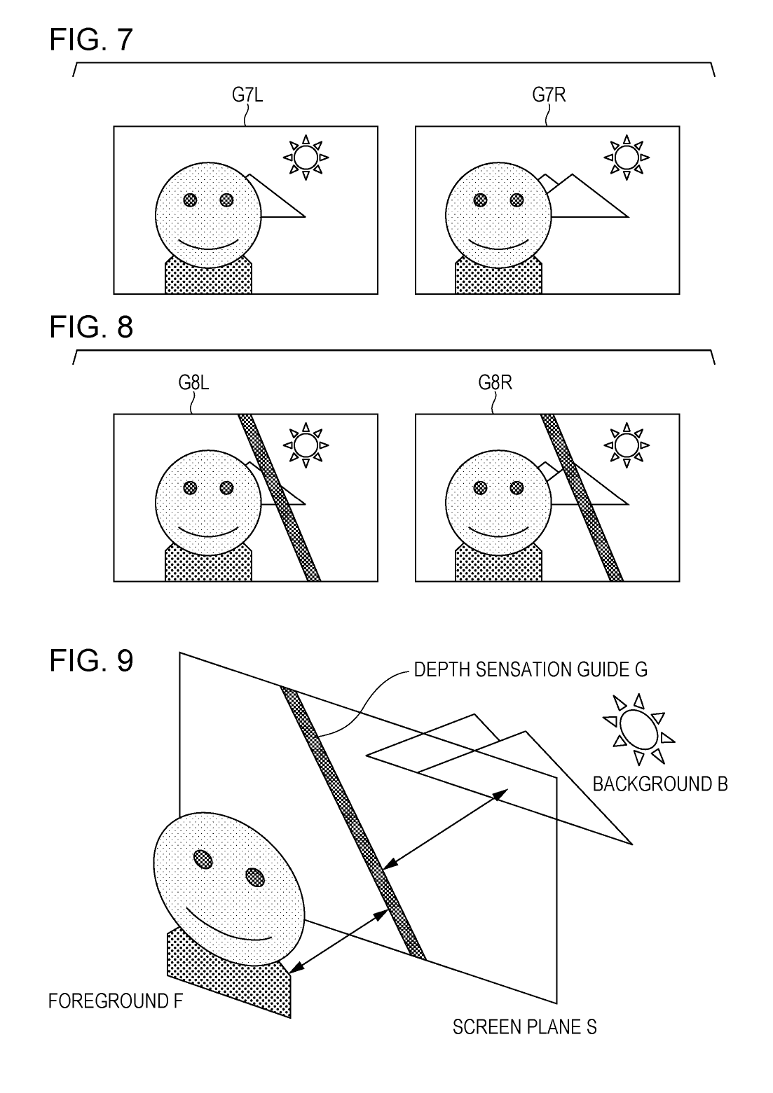

FIG. 7 to FIG. 9 are conceptual diagrams for describing a depth sensation guide. FIG. 7 is an example of a stereoscopic image to be input. G7L is an image for the left eye, and G7R is an image for the right eye. FIG. 8 is an example of an image where a depth sensation guide has been composited on the input stereoscopic image. A strip-shaped stereoscopic image has been composited on the same position within an image G8L for the left eye and an image G8R for the right eye. FIG. 9 is a diagram for, describing how the stereoscopic image in FIG. 8 is sensed.

As illustrated in FIG. 9, a foreground F is sensed more toward the near side from a depth sensation guide G, and a background B is sensed more toward the back from the depth sensation guide G. The depth sensation guide G is sensed on an image display screen face S, and accordingly, depth sensation of a stereoscopic image in real space (whether a subject (object) protrudes from the image display displaying surface, or is recessed into the back) can readily be sensed.

Note that the foreground mentioned here specifies a subject image displayed so as to be sensed more toward the near side from the image display screen face S, and the background mentioned here specifies a subject image displayed so as to be sensed more toward the far side from the image display screen face S.

With the following description, description will be made regarding a case where a depth sensation guide is displayed so that distance from the image display screen face is sensed to be 0 (parallax is sensed to be 0).

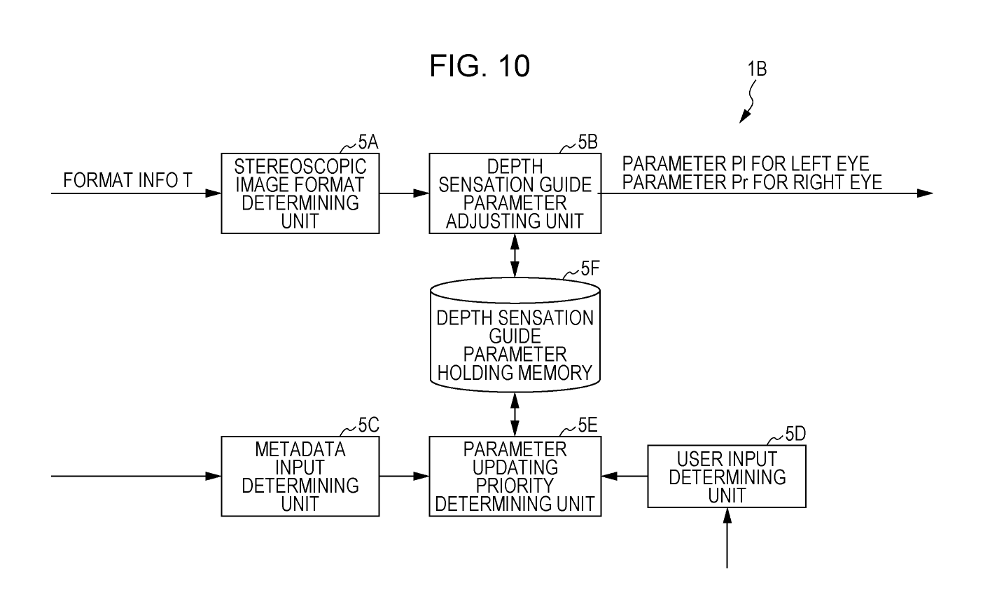

FIG. 10 is a schematic block diagram illustrating a configuration of the depth sensation guide generator 1B.

The depth sensation guide generator 1B is configured to include a stereoscopic image format determining unit 5A, a depth sensation guide parameter adjusting unit 5B, a metadata input determining unit 5C, a user input determining unit 5D, a parameter updating priority determining unit 5E, and depth sensation guide parameter holding memory 5F.

The stereoscopic image format determining unit 5A receives format information T of a stereoscopic image from the stereoscopic image format transmission unit 3D, and transmits this to the depth sensation guide parameter adjusting unit 5B. The depth sensation guide parameter adjusting unit 5B adjusts the depth sensation guide parameters read from the depth sensation guide parameter holding memory 5F based on the format information received from the stereoscopic image format determining unit 5A, generates the parameter Pl for the left eye and parameter Pr for the right eye, and transmits these to the stereoscopic display image generator 1E. The depth sensation guide parameter holding memory 5F has recorded depth sensation guide parameters to be read by the depth sensation guide parameter adjusting unit 5B.

The metadata input determining unit 5C obtains information regarding the depth sensation guide parameters out of the metadata obtained by the metadata input unit 1C, and transmits this to the parameter updating priority determining unit 5E. The user input determining unit 5D obtains information regarding the depth sensation guide parameters from the user input unit 1D, and transmits this to the parameter updating priority determining unit 5E. The parameter updating priority determining unit 5E receives the information regarding the depth sensation guide parameters from the metadata input determining unit 5C, and the information regarding the depth sensation guide parameters from the user input determining unit 5D, determines, based on information of the updating priority flag regarding the parameters recorded in the depth sensation guide parameter holding memory 5F, which parameter is selected, and updates the values of the depth sensation guide parameters stored in the depth sensation guide parameter holding memory 5F.

With regard to the switching timing for turning on/off a depth sensation guide, in the event of turning on, the depth sensation guide is turned on based on the flag information of on/off of the depth sensation guide obtained from the metadata input determining unit 5C or user input determining unit 5D. In the event of turning off, as with the above, the depth sensation guide may be turned off based on the flag information of on/off of the depth sensation guide, or may automatically be turned off after elapse of certain time since the depth sensation guide was turned on. In the event of automatically turning off, existing display time set as a depth sensation guide parameter is employed as the above certain time. Also, in the case of automatically turning off, a mode (automatic off mode or the like) can be selected by using a user interface, for example, such as a remote controller or the like as the user's input.

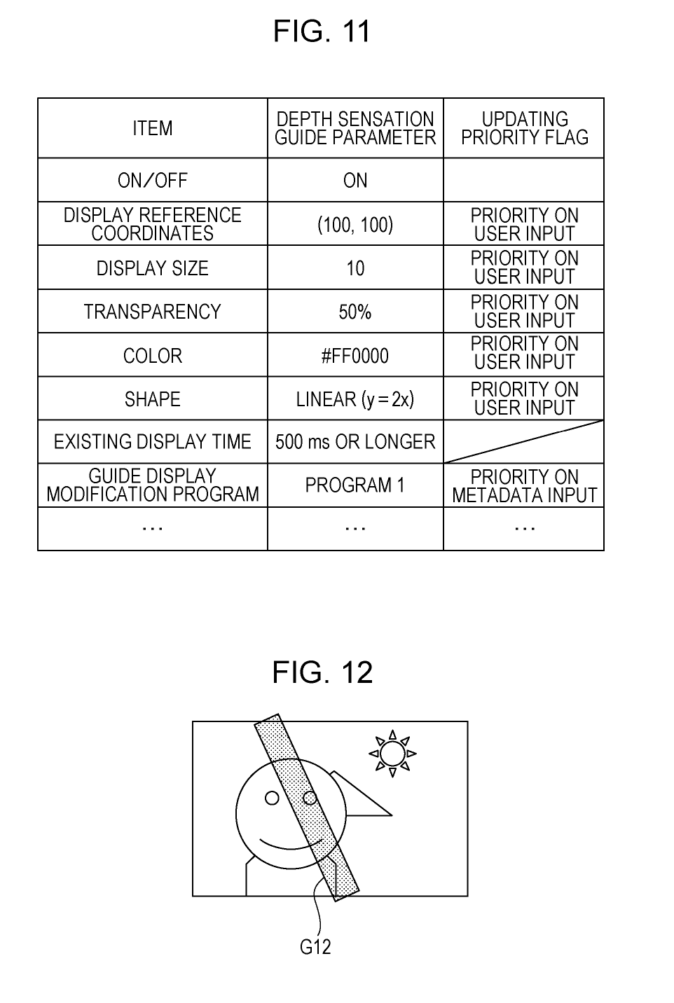

FIG. 11 is a diagram illustrating an example of the depth sensation guide parameters and updating priority flag. The depth sensation guide parameters include, as items, various parameters for an image such as “on/off”, “display reference coordinates”, “size”, “transparency”, “color”, “shape”, and so forth, “existing display time” that indicates time since the depth sensation guide started to be displayed until the depth sensation guide is eliminated (milliseconds (ms) in FIG. 11, but may be the number of frames), “guide display modification program” that specifies a program for changing a parameter such as the above display reference coordinates or the like for each frame, a program for specifying a depth sensation guide undisplayable region, and so forth. Note that, with the coordinates mentioned here, the upper left edge of each image is taken as the origin, the x axis is taken rightward, and the y axis is taken downward. Also, the updating priority flag has information that indicates whether priority is put on user input or metadata regarding each item of the depth sensation guide parameters.

Of the parameters serving as the above-mentioned images, the item “on/off” is information that indicates whether to display a depth sensation guide, when a value thereof is “on”, this indicates that a depth sensation guide is displayed, and when the value thereof is “off”, this indicates that no depth sensation guide is displayed. The item “shape” is information that indicates the shape of a depth sensation guide, the value “linear (y=2×)” in FIG. 11 indicates that the shape is a linear shape (strip shape) of which the inclination is “2”. The item “display reference coordinates” is information that indicates coordinates serving as a reference at the time of displaying a depth sensation guide, and in the event that the value of the item “shape” is “linear (y=2×)”, this indicates that the depth sensation guide passes through the coordinates, and has a linear shape (strip shape) of which the inclination is “2”. The item “display size” is, in the event that the value of the item “shape” is “linear (y=2×)” for example, the thickness of a straight line (width in the x-axis direction).

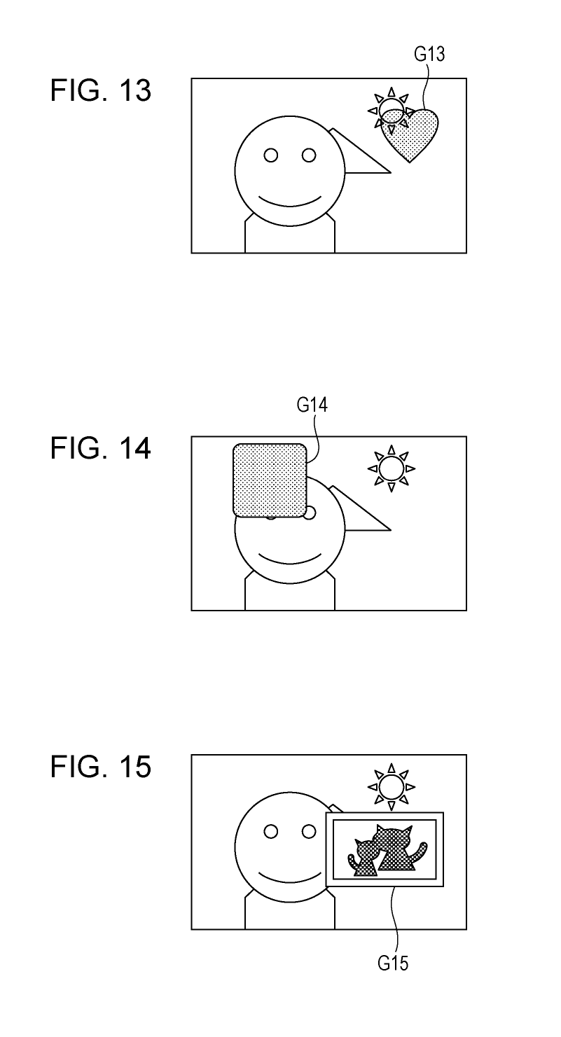

The item “color” specifies the color of a depth sensation guide, and is #FF0000 (red), for example. As information that specifies a color, a pixel value itself may be employed as described above, or an arrangement may be made wherein an LUT (Look Up Table) is prepared beforehand, and an index to select from the LUT is employed. The item “transparency” is transparency at the time of compositing a depth sensation guide and a stereoscopic image, and is expressed with a percentage such as 50%, for example. The parameter of the transparency is combined with the parameter of the color, thereby enabling an expression such as an expression over which a color filter is covered as illustrated in FIG. 12 or FIG. 13.

Note that, in the event of the depth sensation guide parameter as illustrated in FIG. 11, the depth sensation guide serves as a role like a red filter. That is to say, it can be conceived that with a red-pixel portion within an image, no depth sensation guide is sensed, and a role thereof is not realized. Therefore, by setting a negative mode as the value of the item “color” of the depth sensation guide parameters, there may be performed with negative mode display wherein the color of a portion overlapped with a depth sensation guide is converted into the complimentary color of the color of the corresponding pixel (pixel value inverse display). Also, by setting a gray mode as the value of the item “color” of the depth sensation guide parameters, there may be displayed with gray mode display wherein the color of a portion overlapped with a depth sensation guide is converted into an achromatic color according to the luminance value of the corresponding pixel. Also, as other than the complimentary color mode and gray mode, by setting a predetermined value as the value of the item “color”, a value obtained by subjecting the pixel value of the corresponding pixel within a stereoscopic image to predetermined calculation may be employed as a pixel value.

Note that the negative mode display mentioned here is display wherein, when the pixel values of red, green, and blue are R, G, and B respectively, these are replaced with pixel values R′, G′, and B′, converted as follows.

R′=PixMax−R

G′=PixMax−G

B′=PixMax−B

The PixMax mentioned here is, for example, 255 or the like in a system whereby 8-bit gradation can be expressed, and 1023 or the like in a system whereby 10-bit gradation can be expressed, and is a value depending on systems.

Also, the gray mode display mentioned here is display wherein the values are replaced with pixel values R′, G′, and B′, converted as follows.

Y=0.2126×R+0.7152×G+0.0722×B

R′=Y

G′=Y

B′=Y

The value of each of the items may be set finely, but an arrangement may be made wherein templates whereby a depth sensation guide effectively works is prepared beforehand, and a template is selected therefrom. For example, with regard to the shape of a depth sensation guide, as illustrated in FIG. 12 to FIG. 20, there can be conceived various forms such as a straight line, a square, an optional outer shape, an image, and so forth, and accordingly, it is desirable to read one from prepared templates. Also, the number of depth sensation guides and the number of parameters thereof may be two or more, or various types of data may be obtained for the shape of a depth sensation guide via the metadata input unit 1C and metadata input determining unit 5C.

An example illustrated in FIG. 12 is an example of a depth sensation guide G12 according to the depth sensation guide parameters illustrated in FIG. 11. With this depth sensation guide G12, the shape is linear (strip shape), and for example, transparency such as 50% has been set, and accordingly, a portion where the depth sensation guide G12 and a person within a stereoscopic image are overlapped has a color where the colors of both are mixed. An example illustrated in FIG. 13 is a depth sensation guide G13 having a heart shape. With the depth sensation guide G13 as well, for example, transparency such as 50% or the like has been set, and accordingly, a portion where the depth sensation guide G13 and background (sun) within a stereoscopic image are overlapped has a color where the colors of both are mixed.

An example illustrated in FIG. 14 is a depth sensation guide G14 having a square shape. With the depth sensation guide G14, transparency has been set to 0%, and accordingly, the depth sensation guide G14 is displayed at a portion where the depth sensation guide G14 and a person within a stereoscopic image are overlapped. An example illustrated in FIG. 15 is a depth sensation guide G15 of which the shape is an image (texture). As the value of the item “shape”, a preset image (texture) may be specified, or an image (texture) that the user has prepared may be specified with a file name or the like.

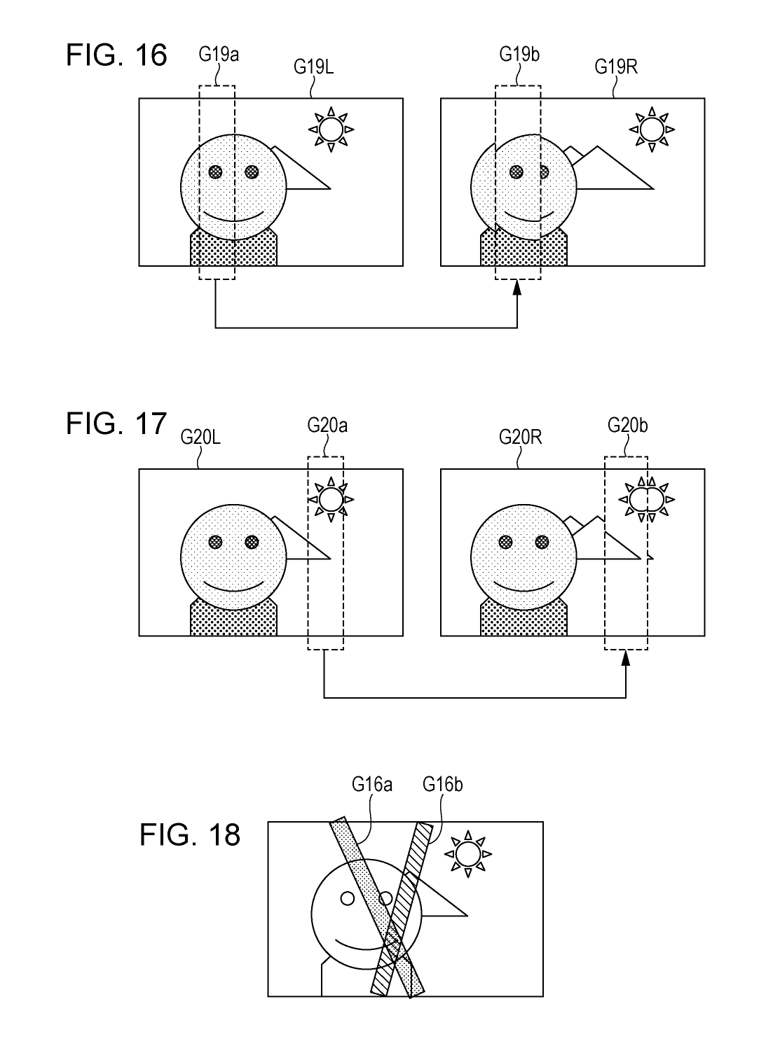

Here, with description in FIG. 15, though a preset image (texture) or an image (texture) specified by the user is assumed, one image within the stereoscopic image may be employed as texture information. For example, an example of a case where the image (texture) is a two-viewpoint stereo image is illustrated in FIG. 16. With the example illustrated in FIG. 16, a portion (G19a) of an image G19L for the left eye is displayed on a region (G19b) having the same coordinates as with the G19a within an image G19R for the right eye, thereby providing a depth sensation guide. The shape of this depth sensation guide is set in the depth sensation guide parameters. Also, the G19a and G19b have the same position as with the image G19L for the left eye and the image G19R for the right eye respectively, and accordingly, this region has no parallax regarding, and is sensed on the image display screen face.

Note that, as will be described later, in the event of having the user sense change over time by changing a display position of a depth sensation guide for each frame, the image (texture) of the depth sensation guide will be taken as an image according to the display position. That is to say, as illustrated in FIG. 17, according to elapse of time from the state in FIG. 16, an image in a position different from the G19a, which is a portion (G20a) of an image G20L for the left eye, is displayed on a region (G20b) having the same coordinates as with the G20a within an image G20R for the right eye, thereby providing a depth sensation guide.

Also, in FIG. 16 and FIG. 17, though description has been made wherein a portion of the image for the left eye is displayed on the same position of the image for the right eye, a portion of the image for the right eye may be displayed on the same position of the image for the left eye.

Also, with a surface where a depth sensation guide is displayed, physical distance from the screen face is 0, the depth sensation guide for the image for the left eye has the same pixel value, and accordingly, the information volume of the depth sensation guide parameter (Pl) may also be reduced.

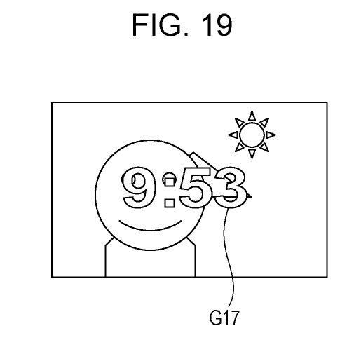

An example illustrated in FIG. 18 is an example of a case where multiple depth sensation guides are displayed, and is an example wherein two depth sensation guides G16a and G16b having a linear shape and different inclination are displayed. In this case, with regard to each of the depth sensation guides G16a and G16b, items such as a color and transparency and so forth may be able to be specified. An example illustrated in FIG. 19 is a depth sensation guide G17 where point-in-time information is obtained from an image display apparatus or a video content or the like, and is taken as a shape, for example.

Note that addition of a template may be performed via the metadata input determining unit 5C or user input determining unit 5D.

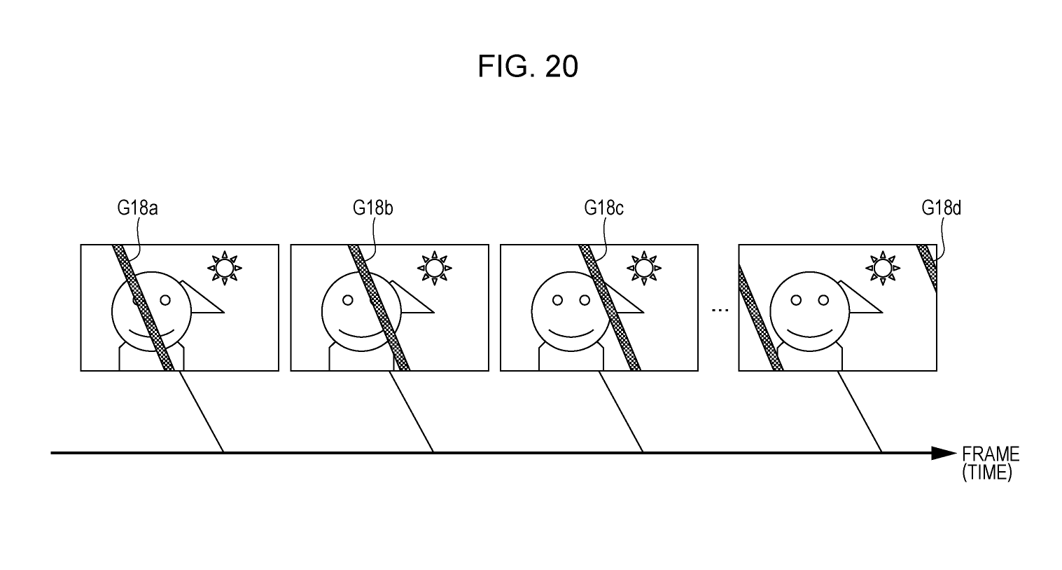

Further, the value of each parameter may be changed for each image frame as programmed in a guide display modification program. With an example illustrated in FIG. 20, display reference coordinates are changed for each frame, thereby changing the display position in the horizontal direction for each frame such as depth sensation guides G18a, G18b, G18c, . . . , G18d. This is sensed by the viewer such that the depth sensation guide moves in the horizontal direction on the screen face over time.

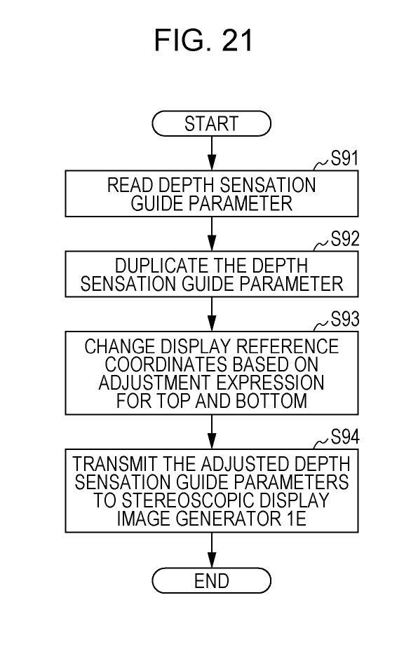

FIG. 21 is a flowchart illustrating an example of a processing flow of the depth sensation guide parameter adjusting unit 5B. This processing flow is a processing flow in a case where the format of a stereoscopic image at the stereoscopic display image generator 1E is the top-and-bottom format. First, in step S91, the depth sensation guide parameter adjusting unit 5B reads out depth sensation guide parameters from the depth sensation guide parameter holding memory 5F. Next, in step S92, the depth sensation guide parameter adjusting unit 5B duplicates the read depth sensation guide parameters to two in order to apply these to an image for the left eye and an image for the right eye, and these depth sensation guide parameters will be taken as parameters for the left eye and parameters for the right eye.

Next, in step S93, the depth sensation guide parameter adjusting unit 5B uses the following adjustment Expressions (1) to (4) for the top-and-bottom format to change (adjust) the values of the display reference coordinates of the parameters for the left eye and parameters for the right eye.

x_LEFT_CORRECT=x_LEFT (1)

x_RIGHT_CORRECT=x_RIGHT (2)

y_LEFT_CORRECT=y_LEFT/2 (3)

y_RIGHT_CORRECT=(y_RIGHT+Height)/2 (4)

Here, the x_LEFT is an x coordinate value of the display reference coordinates of the parameters for the left eye before adjustment. The x_RIGHT is an x coordinate value of the display reference coordinates of the parameters for the right eye before adjustment. The y_LEFT is a y coordinate value of the display reference coordinates of the parameters for the left eye before adjustment. The y_RIGHT is a y coordinate value of the display reference coordinates of the parameters for the right eye before adjustment. The x_LEFT_CORRECT is an x coordinate value of the display reference coordinates of the parameters for the left eye after adjustment. The x_RIGHT_CORRECT is an x coordinate value of the display reference coordinates of the parameters for the right eye after adjustment. The y_LEFT_CORRECT is a y coordinate value of the display reference coordinates of the parameters for the left eye after adjustment. The y_RIGHT_CORRECT is a y coordinate value of the display reference coordinates of the parameters for the right eye after adjustment. The Height is height of an image for the left eye in a top-and-bottom image.

Note that the format of a stereoscopic image may have a format other than the stereoscopic image formats as described above (side-by-side, top-and-bottom, and frame sequential).

In this manner, with the adjustment Expressions (1) and (2) for top-and-bottom, the display reference coordinates agree between the parameters for the left eye and the parameters for the right eye. That is to say, with regard to the depth sensation guide, the parallax is “0”, and accordingly, the depth sensation guide is displayed so that it is sensed that the depth sensation guide is on the image display screen face. Note that the depth sensation guide has to be adjusted so that it is sensed that the depth sensation guide is on the image display screen face or in the vicinity thereof, and accordingly, as long as adjustment is made so that the parallax becomes “0” or an extremely small value, an adjustment method other than the above may be employed.

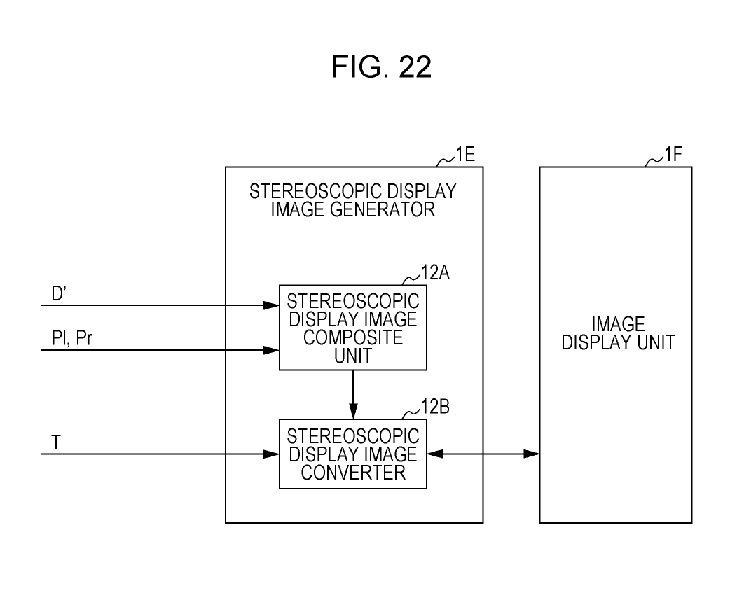

FIG. 22 is a schematic block diagram illustrating a configuration of the stereoscopic display image generator 1E. As illustrated in FIG. 22, the stereoscopic display image generator 1E is configured to include a stereoscopic display image compositing unit 12A and a stereoscopic display image converter 12B. The stereoscopic display image compositing unit 12A uses the parameter Pl for the left eye and the parameter Pr for the right eye to composite a depth sensation guide on the image data D′ of a stereoscopic image.

The stereoscopic display image converter 12B converts the data of the stereoscopic image composited and generated by the stereoscopic display image compositing unit 12A into a format that can be displayed by the image display unit 1F. Note that the stereoscopic display image converter 12B obtains format information T from the stereoscopic image input unit 1A, and handles this format as a format of the data of the stereoscopic image generated by the stereoscopic display image compositing unit 12A.

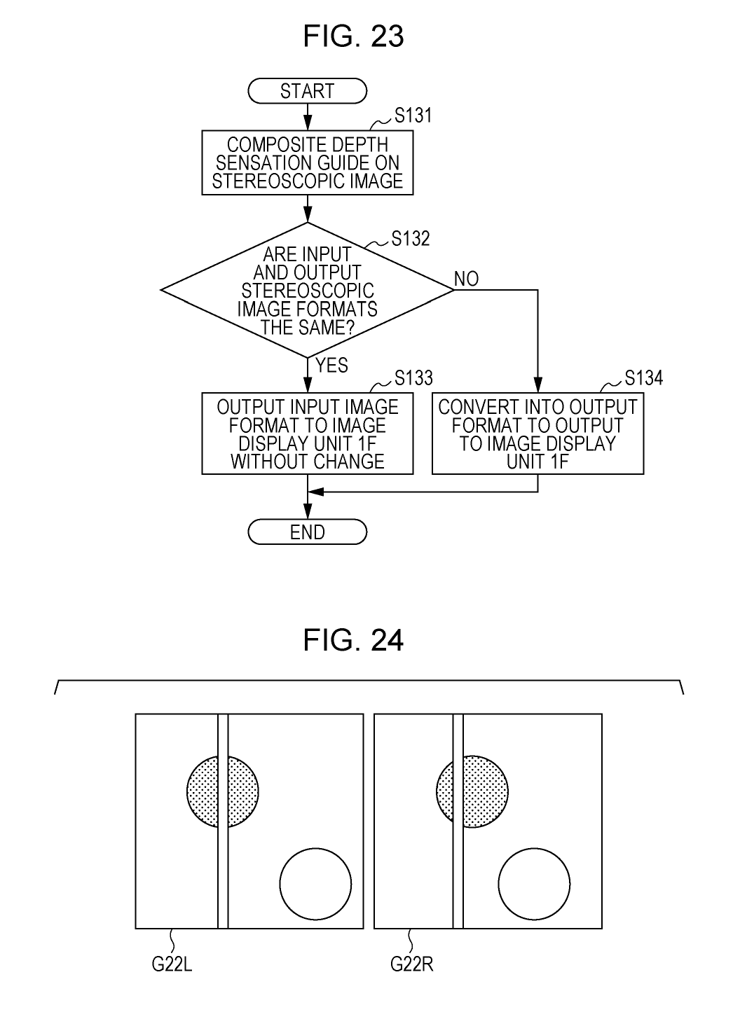

FIG. 23 is a flowchart for describing operation of the stereoscopic display image generator 1E. First, in step S131, the stereoscopic display image compositing unit 12A composites the depth sensation guide on the image data D′, based on the image data D′ output from the stereoscopic image data transmission unit 3C and the parameter Pl for the left eye and the parameter Pr for the right eye output from the depth sensation guide parameter adjusting unit 5B. Here, a compositing method of the depth sensation guide may be realized by calculating a pixel value of the depth sensation guide based on the parameter Pl for the left eye and the parameter Pr for the right eye, and overwriting this on the pixel data of the image data D′, or the value of pixel data corresponding to the image data D′ may be changed based on the parameter Pl for the left eye and the parameter Pr for the right eye.

Next, in step S132, the stereoscopic display image converter 12B obtains the format of a stereoscopic image that the image display unit 1F handles from the image display unit 1F, and compares the obtained format and a format that the format information T output from the stereoscopic image format transmission unit 3D indicates. As a result of this comparison, when these formats are the same (Y in S132), the stereoscopic display image converter 12B transmits the image data composited by the stereoscopic display image compositing unit 12A to the image display unit 1F without change (S133). On the other hand, as a result of the comparison in step S132, when those formats are not the same, the stereoscopic display image converter 12B converts the format of the image data composited by the stereoscopic display image compositing unit 12A into the format of a stereoscopic image that the image display unit 1F handles, and transmits the data to the image display unit 1F (S134).

As described above, by obtaining from the image display unit 1F the format of a stereoscopic image that the image display unit 1F handles, for example, even in the event that the format that the image display unit 1F handles has been changed due to that the image output device (image display unit 1F) has been replaced, or the like, a stereoscopic image on which the depth sensation guide has been composited may be generated and displayed without changing the configuration up to the stereoscopic display image generator 1E.

With a binocular stereoscopic image display method, distortion occurs in stereoscopic spatial reproduction (the image is not sensed in the same way as in real space) due to disagreement of adjustment (focus position of the left and right eyes) and convergence (intersection between the left and right eyes). That is to say, depth sensation is not strictly sensed. However, as described above, when a depth sensation guide is displayed on the image display screen or in the vicinity thereof so as to be sensed, an adjustment position agrees with a convergence position, which becomes a position where spatial distortion is not caused on depth sensation. Therefore, with regard to a depth sensation guide, depth in real space may accurately be sensed. Accordingly, this depth sensation guide is taken as a reference, whereby a position of an object in the forward and backward directions within a stereoscopic image can be recognized. That is to say, the stereoscopic image processing apparatus 10 according to the present embodiment can generate a stereoscopic image whereby a viewer can readily recognize a position in the forward and backward directions of an object within a stereoscopic image.

Also, as with FIG. 20, moving a depth sensation guide can prevent the depth sensation guide from being constantly overlapped with a principal subject within a stereoscopic image and prevent the principal subject from hardly being viewed.

### Second Embodiment

With a second embodiment, a depth sensation guide is displayed so as not to cause binocular rivalry.

Note that the binocular rivalry mentioned here is a phenomenon wherein in the event that stimulation (luminance, color, size, etc.) to be provided to both eyes differs from each other, an image to be sensed is successively switched between both eyes. FIG. 24 to FIG. 26 are diagrams illustrating image examples for describing binocular rivalry. Now, description will be made with a case where stereoscopic vision is realized by the parallel method.

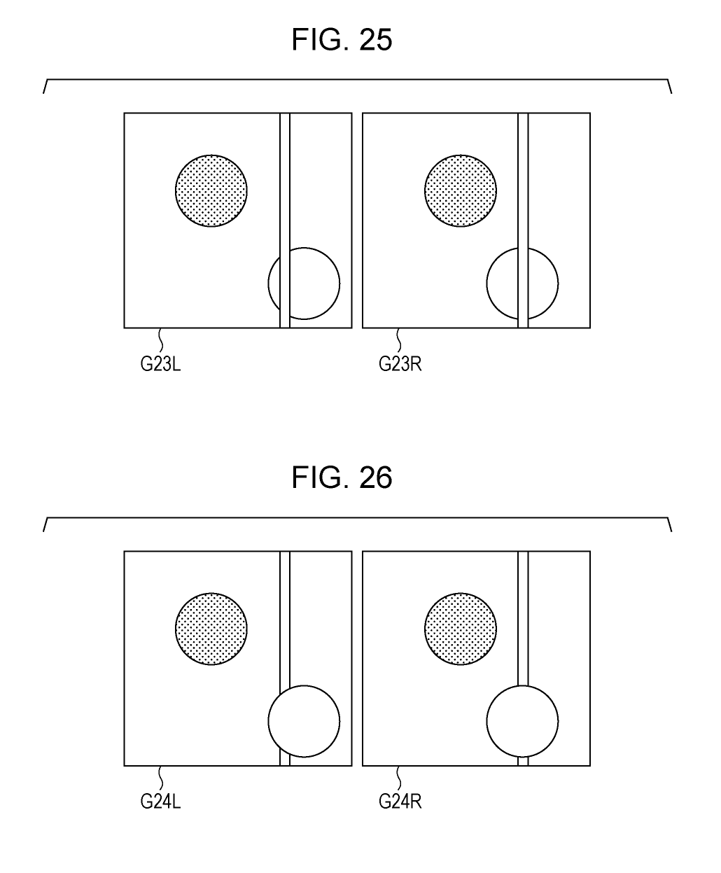

When performing stereoscopic vision of an image G22L for the left eye and an image G22R for the right eye in FIG. 24, a shaded circular shape is sensed more toward the far side than a display surface, a white vertical bar is sensed on the display surface, and a white circular shape is sensed more toward the near side than the display surface. Therefore, even when the white vertical bar is drawn overlapped with the shaded circular shape, stereoscopic vision can normally be performed without discomfort. When performing stereoscopic vision of an image G23L for the left eye and an image G23R for the right eye in FIG. 25, in the same way as with FIG. 24, a shaded circular shape is sensed more toward the far side than a display surface, a white vertical bar is sensed on the display surface, and a white circular shape is sensed more toward the near side from the display surface. However, in FIG. 25, the white vertical bar is drawn overlapped with the white circular shape to be sensed more toward the near side from the white vertical bar, and accordingly, stereoscopic vision cannot normally be performed, and flickering is sensed. This is binocular rivalry. On the other hand, in FIG. 26, with a white vertical bar, a portion overlapped with a white circular shape sensed more toward the near side from the white vertical bar is not drawn, and accordingly, when performing stereoscopic vision of an image G24L for the left eye and an image G24R for the right eye in FIG. 26, stereoscopic vision can normally be performed without discomfort.

With the present embodiment, depth data as to a stereoscopic image to be displayed is obtained, and as with the white vertical bar in FIG. 26, a depth sensation guide is not displayed on a subject more toward the near side from the depth sensation guide (i.e., more toward the near side from the display screen), or a depth sensation guide is displayed with translucence so as not to cause binocular rivalry.

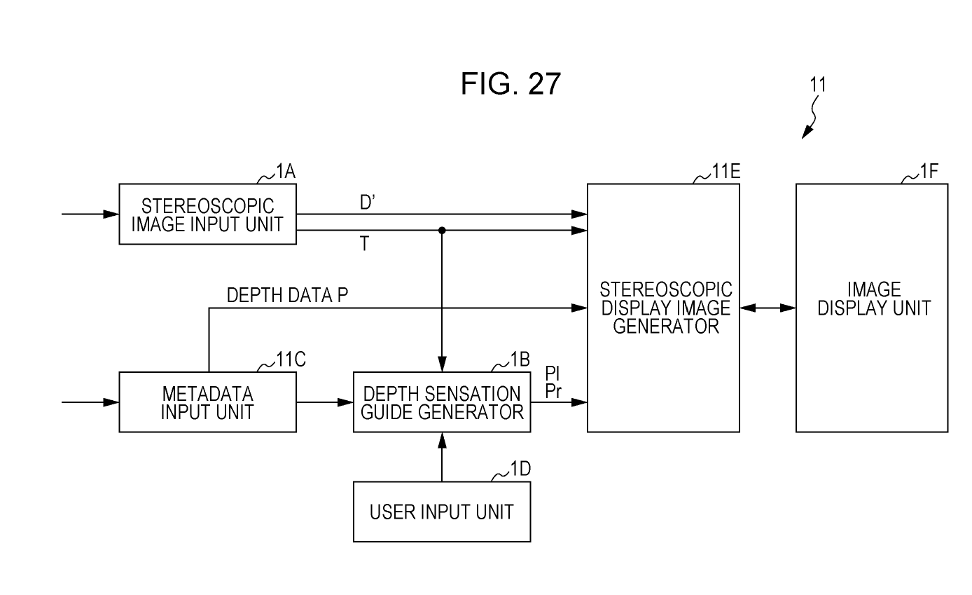

FIG. 27 is a schematic block diagram illustrating a configuration of a stereoscopic image processing apparatus 11 according to the present embodiment. In this drawing, portions corresponding to the units in FIG. 1 are denoted with the same reference symbols (1A, 1B, 1D, and 1F) respectively, and description will be omitted. The stereoscopic image processing apparatus 11 is configured to include the stereoscopic image input unit 1A, the depth sensation guide generator 1B, a metadata input unit 11C, the user input unit 1D, the stereoscopic display image generator 11E, and the image display unit 1F.

The metadata input unit 11C externally accepts, in the same way as with the metadata input unit 10 in FIG. 1, input of various types of metadata, but differs from the metadata input unit 10 in that the metadata input unit 11C outputs, of the accepted metadata, depth data P corresponding to the image data of a stereoscopic image accepted by the stereoscopic image input unit 1A, to the stereoscopic display image generator 11E. The stereoscopic display image generator 11E generates, in the same way as with the stereoscopic display image generator 1E in FIG. 1, signals for displaying a stereoscopic image on which a depth sensation guide has been composited, but differs from the stereoscopic display image generator 1E in that at the time of compositing a depth sensation guide, the stereoscopic display image generator 11E uses the depth data P output from the metadata input unit 11C to prevent a depth sensation guide from being displayed on a subject more toward the near side from the depth sensation guide (i.e., more toward the near side from display screen), or to make the depth sensation guide become translucent.

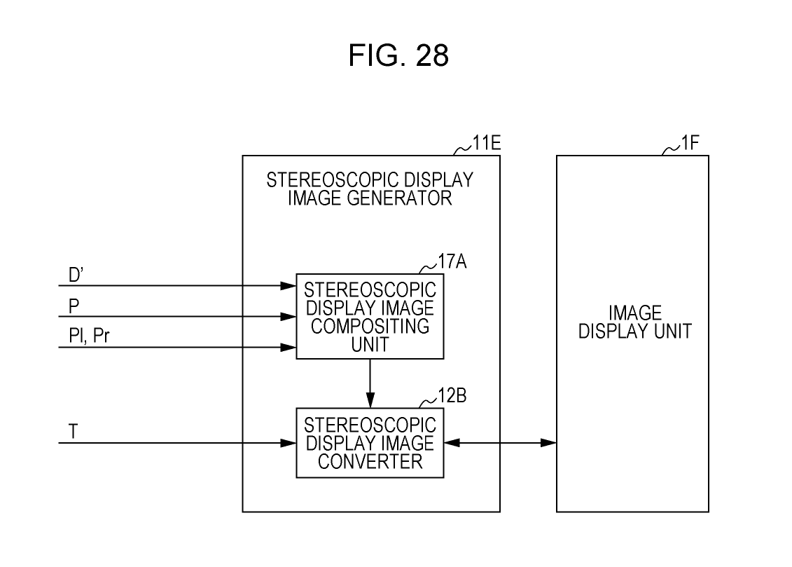

FIG. 28 is a schematic block diagram illustrating a configuration of the stereoscopic display image generator 11E. In this drawing, portions corresponding to the units in FIG. 22 are denoted with the same reference symbols (12B and 1F) respectively, and description will be omitted. The stereoscopic display image generator 11E is configured to include a stereoscopic display image compositing unit 17A, and a stereoscopic display image converter 12B. The stereoscopic display image compositing unit 17A uses the depth data P, parameter Pl for the left eye, and the parameter Pr for the right eye to composite a depth sensation guide on the image data D′ of a stereoscopic image.

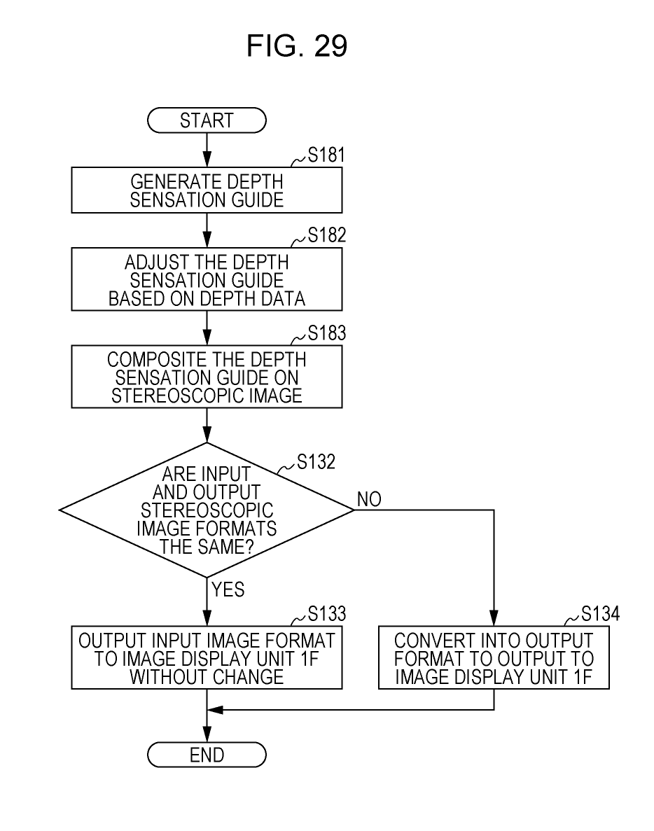

FIG. 29 is a flowchart for describing operation of the stereoscopic display image generator 11E. First, in step S181, the stereoscopic display image compositing unit 17A obtains the parameter Pl for the left eye and the parameter Pr for the right eye of a depth sensation guide, and based on these, generates image data of the depth sensation guide. Next, in step S182, the stereoscopic display image compositing unit 17A adjusts the depth sensation guide generated in step S181 based on the depth data P.

Specifically, for example, the stereoscopic display image compositing unit 17A changes, of the depth sensation guide, the transparency of a portion corresponding to a foreground portion from the depth data P to 100%, thereby preventing the depth sensation guide from being displayed on the foreground portion of a stereoscopic image. Or, an arrangement may be made wherein according to the value of the depth data P, the more toward the front there is a subject, the greater the transparency is increased to be. Also, the value of a composite parameter such as transparency may be different between the foreground portion and the background portion such that the transparency of the foreground portion more toward the near side from the image display screen is set to 70%, and the transparency of the background portion more toward the far side from the image display screen is set to 30%.

Note that, in the event that the depth data P is parallax information, based on whether the value of the parallax is positive or negative, determination may be made whether a subject is more toward the near side or more toward the far side from the image display screen.

Next, in step S183, the stereoscopic display image compositing unit 17A composites the depth sensor guide adjusted in step S182 on the image data D′. Subsequent steps S132 to S134 are the same as steps S132 to S134 in FIG. 23, and accordingly, description will be omitted.

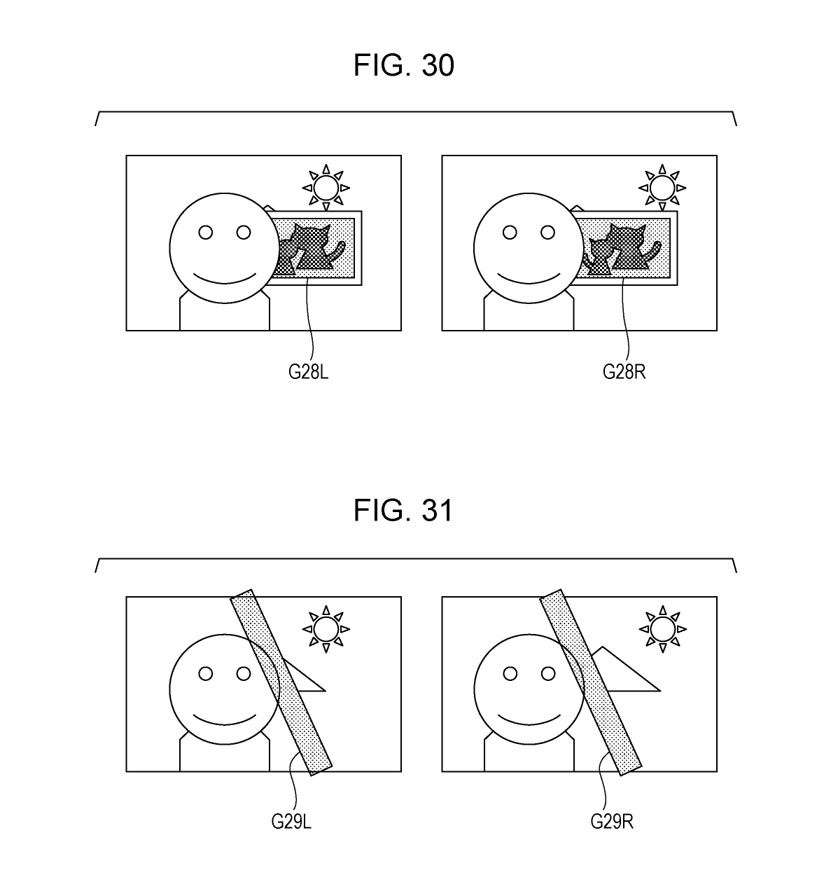

FIG. 30 is a diagram illustrating an example of a depth sensation guide with the transparency of a foreground portion as 100%. With both of a depth sensation guide G28L within an image for the left eye, and a depth sensation guide G28R within an image for the right eye, the transparency of a portion overlapped with a person who is the foreground is set to 100%, and accordingly, the person is displayed instead of the depth sensation guide. Also, the transparency of a portion overlapped with a mountain which is the background is set to 0%, and accordingly, the depth sensation guide is displayed instead of the mountain.

FIG. 31 is a diagram illustrating an example of a depth sensation guide so as to change transparency between a foreground portion and a background portion. With both of a depth sensation guide G29L within an image for the left eye, and a depth sensation guide G29R within an image for the right eye, the transparency of a portion overlapped with a person who is the foreground is set to 50%, and accordingly, the depth sensation guide and person are displayed. Also, the transparency of a portion overlapped with a mountain which is the background is set to 0% here, and accordingly, the depth sensation guide is displayed instead of the mountain.

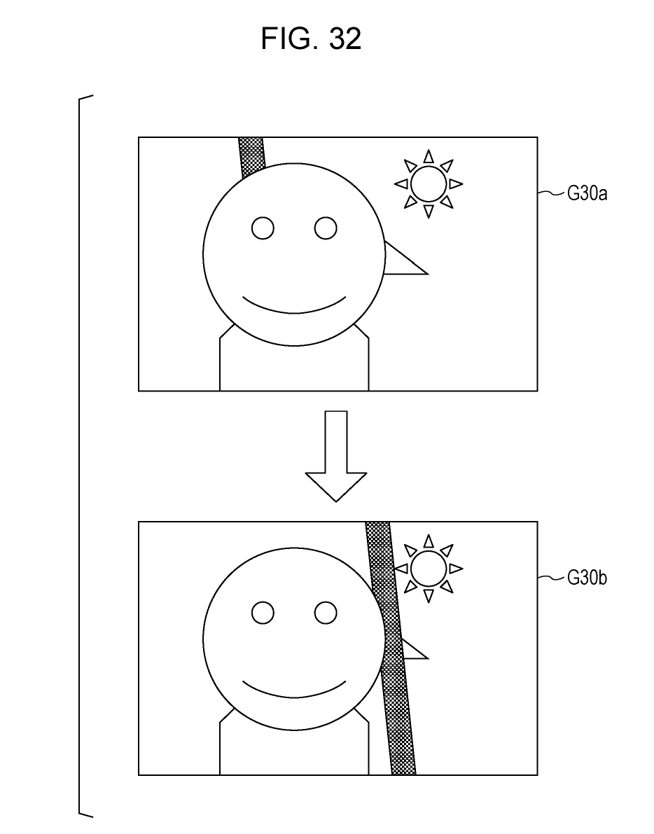

FIG. 32 is a diagram illustrating a modification of a depth sensation guide with the transparency of the depth sensation guide in a foreground portion as 100%. When the transparency in the foreground portion is set to 100%, as illustrated in an image G30a in FIG. 32, the area of the foreground portion may increase as compared to the depth sensation guide, and a portion where the depth sensation guide is displayed may decrease. In order to prevent such a case, when a percentage wherein the number of pixels of a portion to be displayed is occupied in the number of pixels of the depth sensation guide becomes smaller than a predetermined threshold, the stereoscopic display image compositing unit 17A may change the value of the display reference coordinates which is a parameter of the depth sensation guide. According to this change, as with an image G30b in FIG. 32, the depth sensation guide can be moved to a position where a percentage wherein the area of the foreground portion is occupied in the depth sensation guide is lower than a threshold.

Description has been made so far regarding an example wherein transparency is principally changed, but an object to be changed is not restricted to this, for example, the color parameter may be changed, or only a pixel value of the foreground portion may be inverted (negative mode), and further, a display position of a depth sensation guide may be changed.

### Modification of Second Embodiment

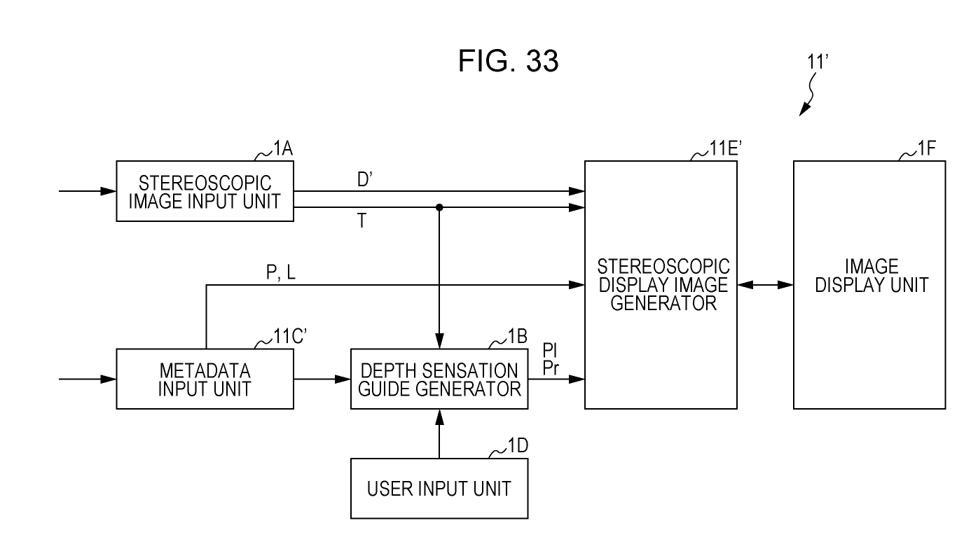

For example, a modification will be described wherein a reference position and a size are changed in combination. FIG. 33 is a′schematic block diagram illustrating a configuration of the stereoscopic image processing apparatus 11′ according to the present modification. In FIG. 33, portions corresponding to the units in FIG. 27 are denoted with the same reference symbols (1A, 1B, 1D, and 1F) respectively, and description thereof will be omitted. The stereoscopic image processing apparatus 11′ is configured to include the stereoscopic image input unit 1A, the depth sensation guide generator 1B, a metadata input unit 11C′, the user input unit 1D, a stereoscopic display image generator 11E′, and the image display unit 1F.

The metadata input unit 11C′ differs from the metadata input unit 11C in FIG. 27 in that the metadata input unit 11C′ outputs, of the received metadata, later-described viewing-and-listening distance L to the stereoscopic display image generator 11E′ in addition to the depth data P. The metadata input unit 11C′ includes a distance measurement sensor such as an infrared irradiation type or the like, detects distance from the stereoscopic image processing apparatus 11′ to the viewer using this distance measurement sensor, and takes this as viewing-and-listening distance L. The stereoscopic display image generator 11E′ differs from the stereoscopic display image generator 11E in FIG. 27 in that the stereoscopic display image generator 11E′ composites a depth sensation guide on the stereoscopic image of the image data D′ using the viewing-and-listening distance L in addition to the depth data P or the like.

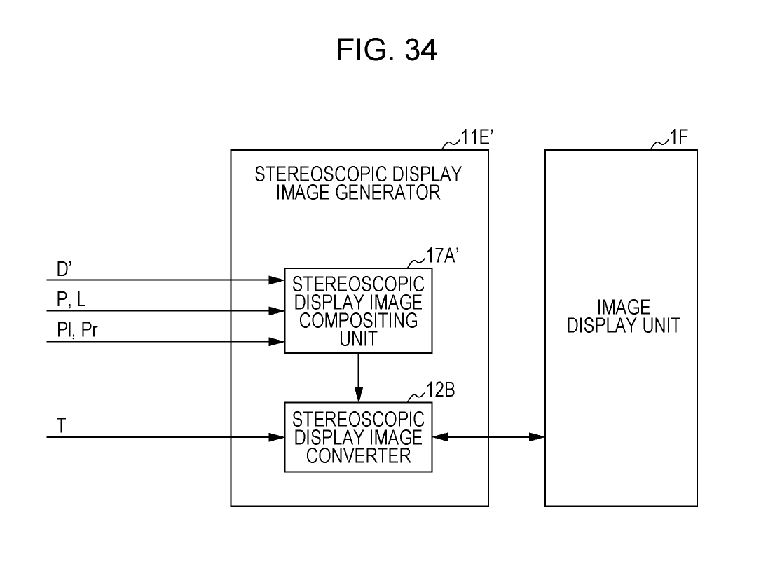

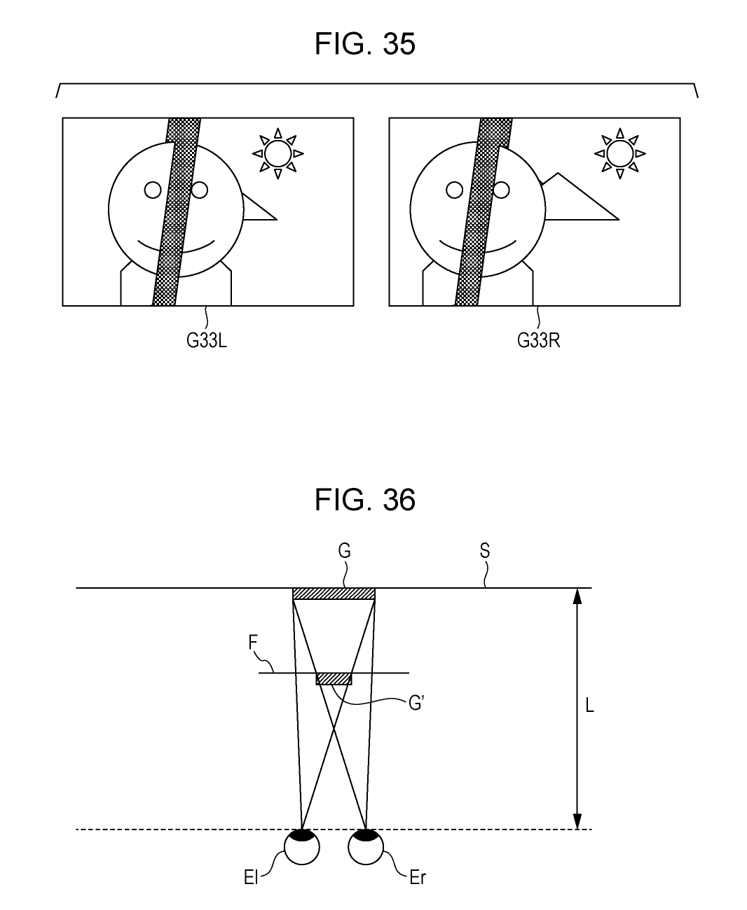

FIG. 34 is a schematic block diagram illustrating a configuration of the stereoscopic display image generator 11E′. In FIG. 34, portions corresponding to the units in FIG. 28 are denoted with the same reference symbols (12B and 1F) respectively, and description thereof will be omitted. The stereoscopic display image generator 11E′ is configured to include a stereoscopic display image compositing unit 17A′, and the stereoscopic display image converter 12B. The stereoscopic display image compositing unit 17A′ uses the viewing-and-listening distance L in addition to the depth data P or the like to composite a depth sensation guide on the stereoscopic image of the image data D′.

FIG. 35 is a diagram illustrating an example of a stereoscopic image composited by the stereoscopic display image compositing unit 17A′. With an image G33L for the left eye in FIG. 35, the lateral width of a depth sensation guide decreases regarding a portion overlapped with a person who is the foreground, and only a part on the right end side thereof is displayed. On the other hand, with an image G33R for the right eye, the lateral width of a depth sensation guide decreases regarding a portion overlapped with a person who is the foreground, and only a part on the left end side thereof is displayed. Here, with regard to lateral width S′ of a portion where only a part is displayed; when parallax of this portion is α, and the item “display size” of the depth sensation parameters is S, the stereoscopic display image compositing unit 17A′ calculates the lateral width S′ using the following expression.

S′=S(1−α/2S)

This is, as illustrated in FIG. 36, an example wherein a guide is composited on only a portion G′ where a common visual field regarding depth sensation guides for both eyes and a foreground object F are overlapped. Note that, in FIG. 36, a reference symbol S is the image display screen, a reference symbol G is a depth sensation guide, a reference symbol F is a foreground object (person), a reference symbol El is a viewpoint for the left eye, a reference symbol Er is a viewpoint for the right eye, and a reference symbol L is distance from the image display screen S to the viewer, that is, the above viewing-and-listening distance. Such display is sensed by the viewer such that of the foreground object F, a hole is opened in a portion of the common visual field G′, and the depth sensation guide G positioned in the back of the foreground object F is seen from the viewer.

Note that, when the metadata input unit 11C′ is unable to obtain the viewing-and-listening distance L, or in the event that the metadata input unit 11C′ has a configuration wherein the viewing-and-listening distance L is unable to be obtained, a standard visual distance value may be taken as the viewing-and-listening distance L. The standard visual distance value is commonly 3H (triple of screen height) in a Full HD image (image of width 1920×height 1080 pixels), for example. Note that a relation between the screen height and standard visual distance depends on the number of vertical pixels of an image.

Also, with the present embodiment as well, in the same way as with FIG. 20, the display position of a depth sensation guide may be changed for each frame.

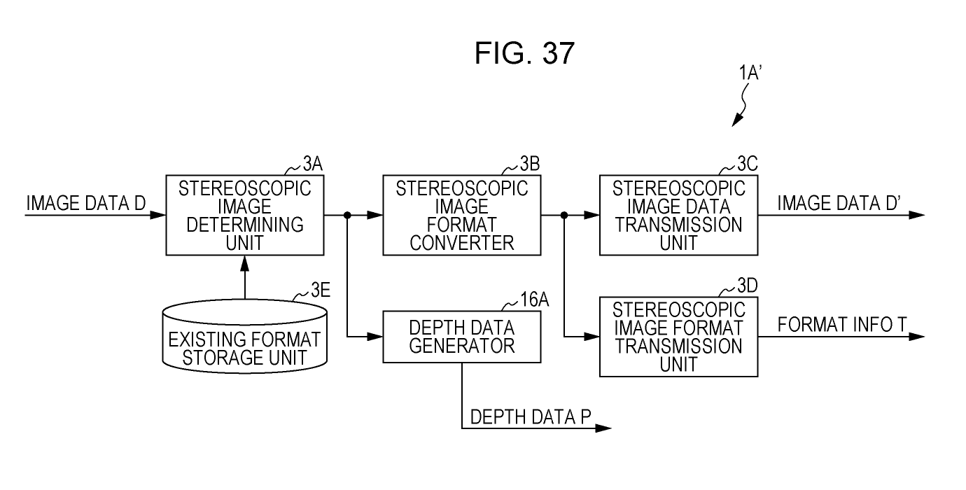

Also, with the above-mentioned second embodiment and modification thereof, though an example has been illustrated wherein the depth data P is obtained as metadata, an arrangement may be made wherein parallax is obtained from an input stereoscopic image by a block matching method or the like, and this is used as the depth data P. FIG. 37 is a schematic block diagram illustrating a configuration of a stereoscopic image input unit 1A′ which is a modification of a stereoscopic image input unit in the event that parallax is obtained, and this is taken as the depth data P. As illustrated in FIG. 37, the stereoscopic image input unit 1A′ differs from the stereoscopic image input unit 1A in that the stereoscopic image input unit 1A′ includes a depth data generator 16A. The depth data generator 16A calculates the depth data P based on the image data of a stereoscopic image output from the stereoscopic image determining unit 3A, and information of a stereoscopic image format. Note that the depth data P to be calculated may be data whereby there can be determined whether more toward the near side from the image display screen face or more toward the far side than that, and is not restricted to the above block matching method.

In this manner, with the second embodiment and modification thereof, the display parameter of a depth sensation guide is changed between a portion overlapped with the foreground, and a portion overlapped with the background, and accordingly, depth sensation within an image can readily be obtained. For example, binocular rivalry can be prevented from occurring by setting the transparency of a portion overlapped with the foreground to 100%. Also, instead of 100%, when increasing the transparency of a portion overlapped with the foreground as compared to that of a portion overlapped with the background, and even when setting to translucence such as 50% or the like, binocular rivalry can be reduced. Even when displaying an image to be displayed from the image display unit 1F as a planar image instead of a stereoscopic image, depth sensation within the image can indirectly be sensed by a depth sensation guide.

With the first embodiment and second embodiment, a two-viewpoint stereo image has been described as an example of the format of a stereoscopic image. However, the present invention is not restricted to this, and may also be applied to a multi-viewpoint stereoscopic image, for example.

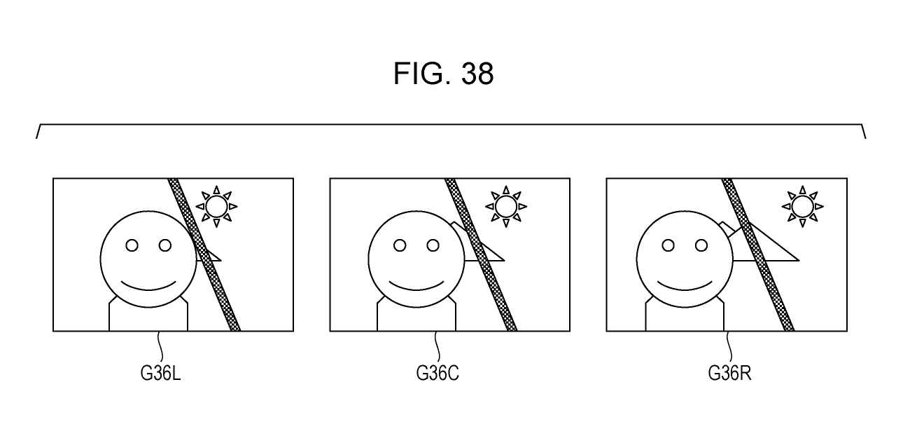

FIG. 38 is a diagram illustrating an example of a three-viewpoint stereoscopic image. G36L denotes the left image, G36C denotes the central image, and G36R denotes the right image.

Now, in the event of handling a multi-viewpoint (three viewpoint or more) stereoscopic image, when the number of viewpoints of a stereoscopic image to be input, and the number of viewpoints of a stereoscopic image to be output are the same, processing can be performed as one kind of stereoscopic image format without changing the configurations or the processing flows illustrated in the first embodiment and second embodiment.

Hereinafter, as an unusual example, description will be made regarding a case where the number of viewpoints of a stereoscopic image to be input, and the number of viewpoints of a stereoscopic image to be output differ.

With third and fourth embodiments, as an example wherein the number of viewpoints of a stereoscopic image to be output is greater than the number of viewpoints of a stereoscopic image to be input, description will be made regarding a case where the stereoscopic image to be input has two viewpoints, and the stereoscopic image to be output has three viewpoints.

As a mode wherein the number of viewpoints of output is greater than that of input, two patterns can be conceived. The first pattern is a pattern to newly generate a third-viewpoint image from two-viewpoint stereoscopic image data and depth data. The second pattern is a pattern to select one of two-viewpoint stereoscopic image data as a third-viewpoint image.

### Third Embodiment

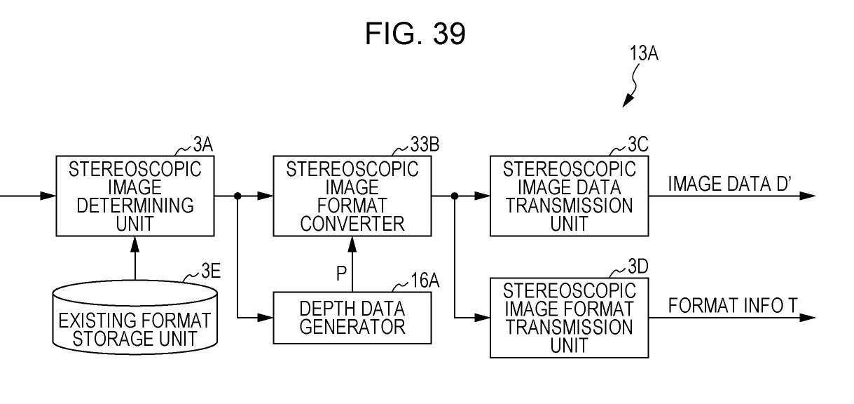

A third embodiment which is an embodiment of the above-mentioned first pattern will be described. A stereoscopic image processing apparatus according to the present embodiment differs from the stereoscopic image processing apparatus 10 illustrated in FIG. 1 in that the stereoscopic image processing apparatus includes a stereoscopic image input unit 13A instead of the stereoscopic image input unit 1A. FIG. 39 is a schematic block diagram illustrating a configuration of the stereoscopic image input unit 13A. In this drawing, portions corresponding to the units in FIG. 37 are denoted with the same reference symbols (3A, 3C to 3E, and 16A) respectively, and description will be omitted. The stereoscopic image input unit 13A is configured to include the stereoscopic image determining unit 3A, a stereoscopic image format converter 33B, the stereoscopic image data transmission unit 3C, the stereoscopic image format transmission unit 3D, the existing format storage unit 3E, and the depth data generator 16A.

The stereoscopic image format converter 33B uses the image data of a two-viewpoint stereoscopic image output from the stereoscopic image determining unit 3A, and the depth data P generated by the depth data generator 16A to generate third-viewpoint (e.g., corresponds to the central image G36C in FIG. 38) image data. Also, the stereoscopic image format converter 33B converts the image data output from the stereoscopic image determining unit 3A, and the generated third-viewpoint image data together into image data D′ of a stereoscopic image having an existing format.

Note that, in the same way as with the stereoscopic image processing apparatus 11′ illustrated in FIG. 33, an arrangement may be made wherein the metadata input unit 11C′ obtains the depth data P, and the stereoscopic image format converter 33B uses this depth data P to generate third-viewpoint image data.

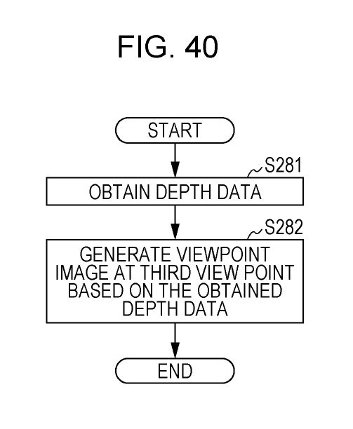

FIG. 40 is a flowchart for describing operation of the stereoscopic image format converter 33B. First, in step S281, the stereoscopic image format converter 33B receives the depth data generated by the depth data generator 16A. Next, in step S282, the stereoscopic image format converter 33B newly generates a third-viewpoint image from the depth data P, and the image data D of a stereoscopic image obtained from the stereoscopic image determining unit 3A.

In this manner, even when an input stereoscopic image has two viewpoints, this stereoscopic image is converted into a stereoscopic image having three viewpoints or more using the depth data, and even with an stereoscopic image having three viewpoints or more, a depth sensation guide is composited thereon in the same way as with the first or second embodiment, whereby there can be generated a stereoscopic image wherein the viewer can readily recognize a position in the forward or backward direction of an object within the stereoscopic image.

### Fourth Embodiment

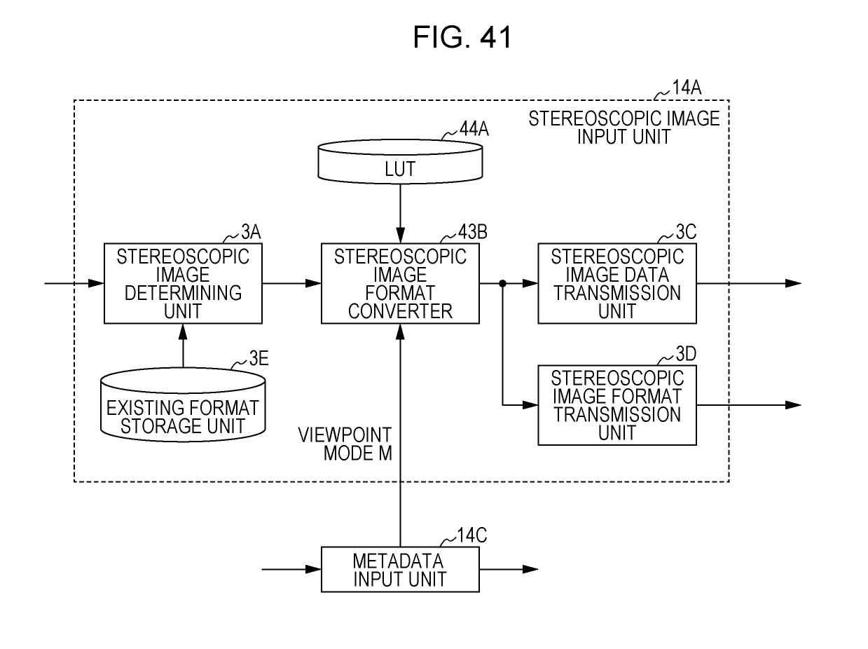

A fourth embodiment which is an embodiment of the above-mentioned second pattern will be described. A stereoscopic image processing apparatus according to the present embodiment differs from the stereoscopic image processing apparatus 10 illustrated in FIG. 1 in that this stereoscopic image processing apparatus includes a stereoscopic image input unit 14A instead of the stereoscopic image input unit 1A, and includes a metadata input unit 14C instead of the metadata input unit 10. FIG. 41 is a schematic block diagram illustrating a configuration of the stereoscopic image input unit 14A and a relation between the stereoscopic image input unit 14A and the metadata input unit 14C. In this drawing, portions corresponding to the units in FIG. 5 are denoted with the same reference symbols (3A, 3C to 3E) respectively, and description will be omitted. The stereoscopic image input unit 14A is configured to include the stereoscopic image determining unit 3A, a stereoscopic image format converter 43B, the stereoscopic image data transmission unit 3C, the stereoscopic image format transmission unit 3D, the existing format storage unit 3E, and an LUT (Look Up Table) 44A.

The metadata input unit 14C differs from the metadata input unit 1C in FIG. 1 in that the metadata input unit 14C outputs, of accepted metadata, a viewpoint mode M to the stereoscopic image format converter 43B. The LUT 44A stores correlation between a viewpoint mode and the configuration of an image in the viewpoint mode beforehand. The stereoscopic image format converter 43B converts, in accordance with the configuration of an image stored in the LUT 44A in a manner correlated with the viewpoint mode M output from the metadata input unit 14C, image data output from the stereoscopic image determining unit 3A into image data of a stereoscopic image in this viewpoint mode.

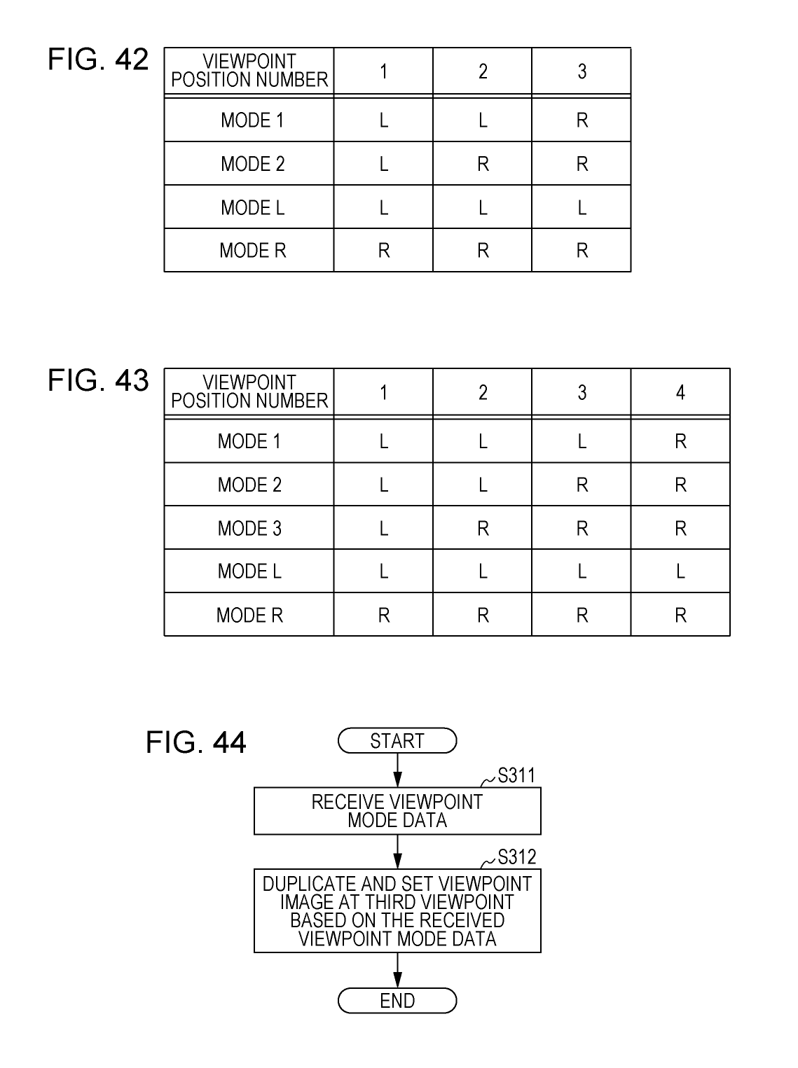

FIG. 42 is a diagram illustrating an example of correlation between a viewpoint mode and the configuration of an image stored in the LUT 44A. This example is an example in a case where the stereoscopic image format converter 43B converts two viewpoints into three viewpoints. With the example illustrated in FIG. 42, when the viewpoint mode is “mode 1”, the first viewpoint is a left image (L) of an input stereoscopic image, the second viewpoint is also the left image, and the third viewpoint is a right image (R). Similarly, when the viewpoint mode is “mode 2”, the first viewpoint is the left image, the second viewpoint is the right image, and the third viewpoint is the right image. When the viewpoint mode is “mode L”, the first viewpoint to third viewpoint are all the left image. When the viewpoint mode is “mode R”, the first viewpoint to third viewpoint are all the right image.

FIG. 43 is a diagram illustrating another example of correlation between a viewpoint mode and the configuration of an image stored in the LUT 44A. This example is an example in a case where the stereoscopic image format converter 43B converts two viewpoints into four viewpoints. With the example illustrated in FIG. 43, when the viewpoint mode is “mode 1”, the first viewpoint is a left image of an input stereoscopic image, the second viewpoint and third viewpoint are also the left image, and the fourth viewpoint is a right image. Similarly, when the viewpoint mode is “mode 2”, the first viewpoint and second viewpoint are the left image, the third viewpoint and fourth viewpoint are the right image. When the viewpoint mode is “mode 3”, the first viewpoint is the left image, and the second viewpoint to fourth viewpoint are the right image. When the viewpoint mode is “mode L”, the first viewpoint to fourth viewpoint are all the left image. When the viewpoint mode is “mode R”, the first viewpoint to fourth viewpoint are all the right image.

FIG. 44 is a flowchart for describing operation of the stereoscopic image format converter 43B. First, in step S311, the stereoscopic image format converter 43B receives the viewpoint mode M from the metadata input unit 14C. In step S312, the stereoscopic image format converter 43B duplicates, based on the viewpoint mode M, a left image or right image, and registers this as a third-viewpoint image.

Note that, with the present embodiment, though description has been made wherein the metadata input unit 14C obtains the viewpoint mode M, an arrangement may be made wherein the user specifies the viewpoint mode M, and this is detected by the user input unit 1D.

In this manner, even when an input stereoscopic image has two viewpoints, this stereoscopic image is converted into a stereoscopic image having three viewpoints or more using the viewpoint data, and even with an stereoscopic image having three viewpoints or more, a depth sensation guide is composited thereon in the same way as with the first or second embodiment, whereby there can be generated a stereoscopic image wherein the viewer can readily recognize a position in the forward or backward direction of an object within the stereoscopic image.

### Fifth Embodiment

With the third and fourth embodiments, as an example of a case where the number of viewpoints of a stereoscopic image to be input is smaller than the number of viewpoints of a stereoscopic image to be output, description has been made regarding a case where a stereoscopic image to be input has two viewpoints, and a stereoscopic image to be output has three viewpoints. With a fifth embodiment, as an example of a case where the number of viewpoints of a stereoscopic image to be output is smaller than the number of viewpoints of a stereoscopic image to be input, description will be made regarding a case where a stereoscopic image to be input has three viewpoints, and a stereoscopic-image to be output has two viewpoints.

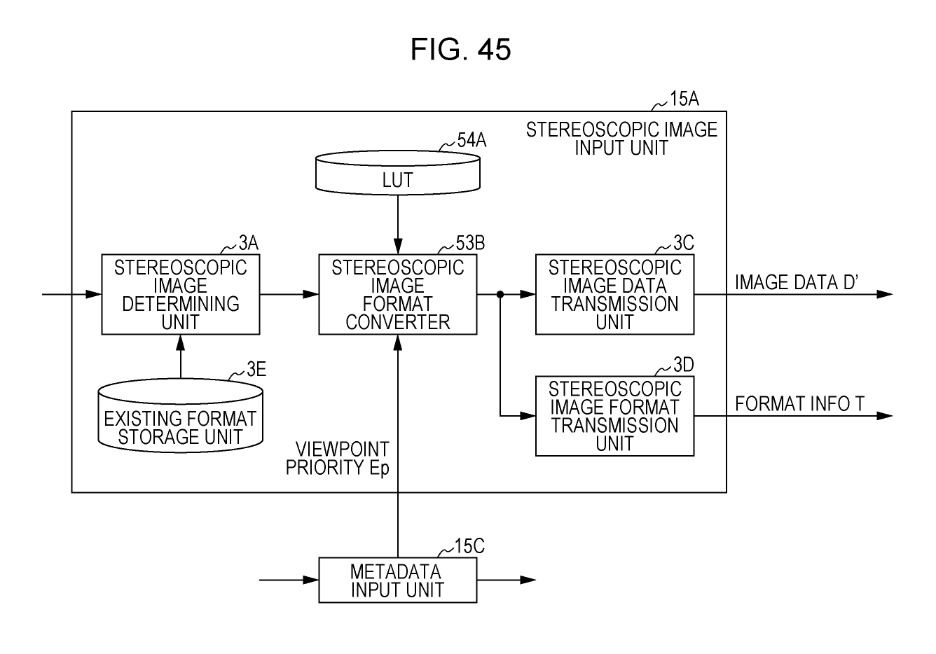

A stereoscopic image processing apparatus according to the present embodiment differs from the stereoscopic image processing apparatus 10 illustrated in FIG. 1 in that this stereoscopic image processing apparatus includes a stereoscopic image input unit 15A instead of the stereoscopic image input unit 1A, and includes a metadata input unit 15C instead of the metadata input unit 1C. FIG. 45 is a schematic block diagram illustrating a configuration of the stereoscopic image input unit 15A and a relation between the stereoscopic image input unit 15A and the metadata input unit 15C. In this drawing, portions corresponding to the units in FIG. 5 are denoted with the same reference symbols (3A, 3C to 3E) respectively, and description will be omitted. The stereoscopic image input unit 15A is configured to include the stereoscopic image determining unit 3A, a stereoscopic image format converter 53B, the stereoscopic image data transmission unit 3C, the stereoscopic image format transmission unit 3D, the existing format storage unit 3E, and an LUT 54A.

The metadata input unit 15C differs from the metadata input unit 10 in FIG. 1 in that the metadata input unit 15C outputs, of accepted metadata, a viewpoint priority Ep to the stereoscopic image format converter 53B. The LUT 54A stores correlation between the viewpoint priority Ep and the configuration of an image in the viewpoint priority Ep beforehand. The stereoscopic image format converter 53B converts, in accordance with the configuration of an image stored in the LUT 54A in a manner correlated with the viewpoint priority Ep output from the metadata input unit 15C, image data output from the stereoscopic image determining unit 3A into image data of a stereoscopic image in this viewpoint priority Ep.

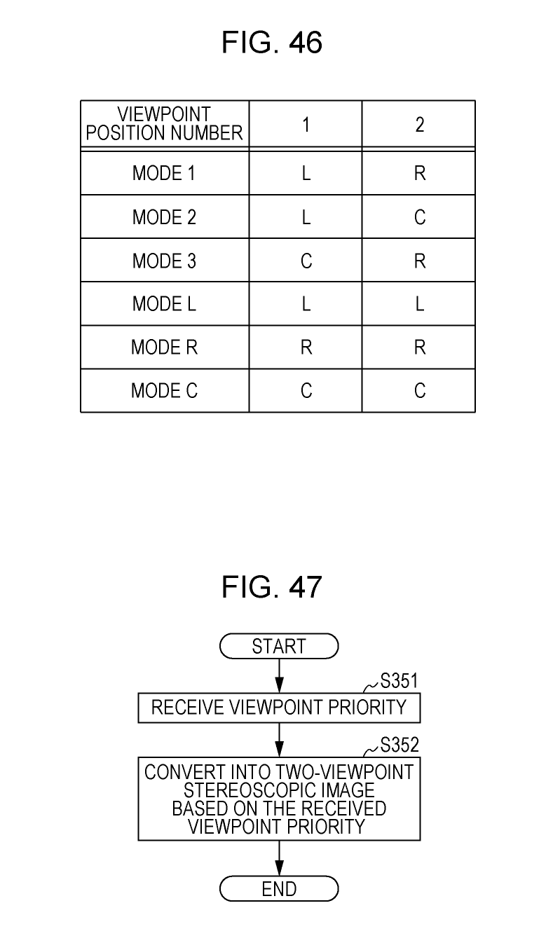

FIG. 46 is a diagram illustrating an example of correlation between a viewpoint priority and the configuration of an image stored in the LUT 54A. With the example illustrated in FIG. 46, when the viewpoint mode is “mode 1”, the first viewpoint is a left image (L) of an input stereoscopic image, the second viewpoint is a right image (R). Similarly, when the viewpoint mode is “mode 2”, the first viewpoint is the left image, and the second viewpoint is a central image (C). When the viewpoint mode is “mode 3”, the first viewpoint is the central image, and the second viewpoint is the right image. When the viewpoint mode is “mode L”, the first viewpoint and second viewpoint are both the left image. When the viewpoint mode is “mode R”, the first viewpoint and second viewpoint are both the right image. When the viewpoint mode is “mode C”, the first viewpoint and second viewpoint are both the central image.

FIG. 47 is a flowchart for describing operation of the stereoscopic image format converter 53B. First, in step S351, the stereoscopic image format converter 53B receives the viewpoint priority Ep. Next, in step S352, the stereoscopic image format converter 53B converts, based on the viewpoint priority Ep, a three-viewpoint stereoscopic image format into an existing two-viewpoint stereoscopic image format.

### Sixth Embodiment

With a sixth embodiment, as an example of a case where the number of viewpoints of a stereoscopic image to be output is smaller than the number of viewpoints of a stereoscopic image to be input, description will be made regarding an example different from the fifth embodiment in a case where a stereoscopic image to be input has three viewpoints, and a stereoscopic image to be output has two viewpoints.

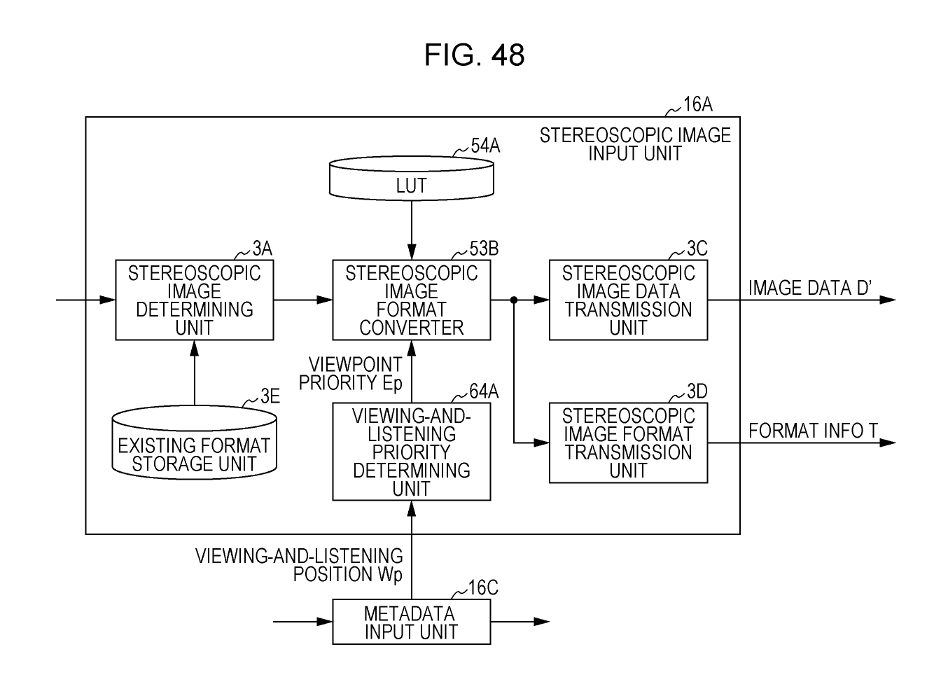

A stereoscopic image processing apparatus according to the present embodiment differs from the stereoscopic image processing apparatus 10 illustrated in FIG. 1 in that this stereoscopic image processing apparatus includes a stereoscopic image input unit 16A instead of the stereoscopic image input unit 1A, and includes a metadata input unit 16C instead of the metadata input unit 10. FIG. 48 is a schematic block diagram illustrating a configuration of the stereoscopic image input unit 16A and a relation between the stereoscopic image input unit 16A and the metadata input unit 16C. In this drawing, portions corresponding to the units in FIG. 45 are denoted with the same reference symbols (3A, 3C to 3E, 53B, and 54A) respectively, and description will be omitted. The stereoscopic image input unit 16A is configured to include the stereoscopic image determining unit 3A, the stereoscopic image format converter 53B, the stereoscopic image data transmission unit 3C, the stereoscopic image format transmission unit 3D, the existing format storage unit 3E, the LUT 54A, and a viewing-and-listening priority determining unit 64A.

The metadata input unit 16C differs from the metadata input unit 1C in FIG. 1 in that the metadata input unit 16C outputs, of accepted metadata, a viewing-and-listening position Wp to the viewing-and-listening priority determining unit 64A. The metadata input unit 16C includes, for example, a person detecting sensor, detects whether the viewer is close to the right side or close to the left side toward the image display screen, and outputs the detection result as the viewing-and-listening position Wp. The viewing-and-listening priority determining unit 64A determines the viewing-and-listening priority Ep according to the viewing-and-listening position Wp output from the metadata input unit 16C, and outputs the determination result to the stereoscopic image format converter 53B. For example, the viewing-and-listening priority determining unit 64A sets the viewing-and-listening priority Ep to “mode 2” when the viewing-and-listening position Wp output from the metadata input unit 16C is close to the left side, and sets the viewing-and-listening priority Ep to “mode 3” when the viewing-and-listening position Wp output from the metadata input unit 16C is close to the right side. Thus, when the viewer is in the left side toward the image display screen, the left image and central image are displayed, and when the viewer is in the right side, the central image and right image are displayed. That is to say, an image viewed from a direction according to the position of the viewer is displayed.

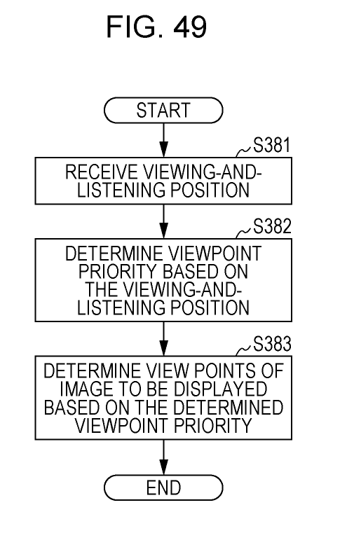

FIG. 49 is a flowchart for describing operation of the viewing-and-listening priority determining unit 64A and stereoscopic image format converter 53B. First, in step S381, the viewing-and-listening priority determining unit 64A receives the viewing-and-listening position Wp from the metadata input unit 16C as metadata.

In step S382, a viewing-and-listening priority data obtaining unit 64A selects, based on the obtained viewing-and-listening position data, a mode in FIG. 46, and transmits viewing-and-listening priority data to the stereoscopic image format converter 53B.

In step S383, the stereoscopic image format converter 53B converts, based on the viewing-and-listening priority data obtained from the viewing-and-listening priority data obtaining unit 64A, a three-viewpoint stereoscopic image format to an existing two-viewpoint stereoscopic image format.

Also, an arrangement may be made wherein a program for realizing the function of the stereoscopic image processing apparatus according to each embodiment or a part of the function thereof is recorded in a computer-readable recording medium, and the program recorded in this recording medium is read and executed by a computer system, thereby performing stereoscopic image processing. Now, “computer system” mentioned here includes an OS and hardware such as peripheral devices.

Also, in the event of employing a WWW system, “computer system” also includes a website providing environment (or display environment).

Also, “computer-readable recording medium” means a portable medium such as a flexible disk, a magneto-optical disk, ROM, CD-ROM, or the like, and a storage device such as a hard disk housed in the computer system, or the like. Further, “computer-readable recording medium” includes something dynamically holding a program during a short period-such as a communication wire in the event of transmitting a program via a communication line such as a network such as the Internet, a telephone line, or the like, and something to hold a program for a certain period of time such as volatile memory within a computer system serving as a server or client in this case. Also, the above-mentioned program may be a program configured to realize a part of the above-mentioned function, and may further be a program that can realize the above-mentioned function by being combined with a program already recording in the computer system.

Though the embodiments of the present invention have been described above in detail with reference to the drawings, specific configurations are not restricted to the embodiments, and design modifications and so forth are also encompassed without departing from the essence of the present invention.

### REFERENCE SIGNS LIST

10, 11, 11′ stereoscopic image processing apparatus
1A, 1A′, 13A, 14A, 15A stereoscopic image input unit
1B depth sensation guide generator
1C, 11C, 11C′, 14C, 15C, 16C metadata input unit
1D user input unit
1E, 11E, 11E′ stereoscopic display image generator
1F image display unit
3A stereoscopic image determining unit
3B, 33B, 43B, 53B stereoscopic image format converter
3C stereoscopic image data transmission unit
3D stereoscopic image format transmission unit
3E existing format storage unit
5A stereoscopic image format determining unit
5B depth sensation guide parameter adjusting unit
5C metadata input determining unit
5D user input determining unit
5E parameter updating priority determining unit
5F depth sensation guide parameter holding memory
12A, 17A, 17A′ stereoscopic display image compositing unit
12B stereoscopic display image converter
16A depth data generator
44A, 54A LUT
64A viewing-and-listening priority determining unit

1. A stereoscopic image processing apparatus configured to generate an image where a guide image that represents a position in real space of a display unit configured to display a stereoscopic image and serves as a reference of depth in the stereoscopic image is overlapped on the stereoscopic image.

2. The stereoscopic image processing apparatus according to claim 1, wherein the guide image is an image to be sensed on an image display screen face of the display unit or on a planar surface in parallel with the image display screen and also in the vicinity of the image display screen face.

3. The stereoscopic image processing apparatus according to claim 2, wherein the guide image is a portion of an image viewed from one viewpoint that makes up the stereoscopic image.

4. The stereoscopic image processing apparatus according to claim 2, wherein based on depth data of the stereoscopic image, an image where the guide image is overlapped on the stereoscopic image is generated.

5. The stereoscopic image processing apparatus according to claim 4, wherein a composite parameter in the event of overlapping the guide image on the stereoscopic image is set to a different value depending on whether a portion where the guide image and the stereoscopic image are overlapped is a foreground portion which is a subject portion to be sensed more toward the near side from the image display screen or a background portion which is a subject portion to be sensed more toward the far side from the image display screen.

6. The stereoscopic image processing apparatus according to claim 5, wherein the composite parameter is transparency of the guide image, and sets transparency in the foreground portion greater than transparency in the background portion.

7. The stereoscopic image processing apparatus according to claim 6, wherein transparency in the foreground portion is 100%.

8. The stereoscopic image processing apparatus according to claim 5, wherein the composite parameter is lateral width of the guide image, and sets lateral width in the foreground portion smaller than lateral width in the background portion.

9. The stereoscopic image processing apparatus according to claim 1, wherein a display position of the guide image is changed for each frame.

10. A stereoscopic image processing method for processing a stereoscopic image, comprising:
generating an image where a guide image that represents a position in real space of a display unit configured to display a stereoscopic image and serves as a reference of depth in the stereoscopic image is overlapped on the stereoscopic image.

11. A non-transitory computer-readable recording medium storing a program causing a computer of a stereoscopic image processing apparatus configured to process a stereoscopic image to execute:
generating an image where a guide image that represents a position in real space of a display unit configured to display a stereoscopic image and serves as a reference of depth in the stereoscopic image is overlapped on the stereoscopic image.
